(19) United States
(12) Patent Application Publication
(10) Pub. No.: US 2024/0078677 A1
(43) Pub. Date: Mar. 7, 2024

(54) SYSTEMS AND METHODS FOR IMAGE PROCESSING

(71) Applicant: SHANGHAI UNITED IMAGING HEALTHCARE CO., LTD., Shanghai (CN)

(72) Inventors: Zheng ZHANG, Shanghai (CN); Yuhang SHI, Shanghai (CN)

(73) Assignee: SHANGHAI UNITED IMAGING HEALTHCARE CO., LTD., Shanghai (CN)

(21) Appl. No.: 18/149,046

(22) Filed: Dec. 30, 2022

(30) Foreign Application Priority Data
Sep. 2, 2022 (CN) 202211071315.6

(51) Int. Cl. G06T 7/00

(52) U.S. Cl. CPC G06T 7/0014; G06T 2207/30096

(57) ABSTRACT

The present disclosure relates to a method for image processing. The method may be implemented on a computing device having at least one storage device storing a set of instructions, and at least one processor in communication with the at least one storage device. The method may include for each stage of at least one stage of a target disease, determining a type of one or more regions of interest (ROIs) corresponding to the stage; generating a first distribution image indicating the distribution of the one or more ROIs corresponding to the stage in a subject by processing a structural image of the subject based on the type of the one or more ROIs; and generating a lesion detection result of the subject by processing a functional image of the subject based on the first distribution image corresponding to the stage.

### CROSS-REFERENCE TO RELATED APPLICATIONS

This application claims priority of Chinese Patent Application No. 202211071315.6 filed on Sep. 2, 2022, the contents of which are incorporated herein by reference.

### TECHNICAL FIELD

The present disclosure generally relates to image processing technology, and in particular, to systems and methods for processing medical images.

### BACKGROUND

Functional and metabolic imaging can be used to detect distribution of imaging agents (e.g., radionuclide tracers) in a patient. For example, a high-concentration point (also referred to as “an abnormal point”) where the radionuclide tracer is abnormally taken up may have a high signal in a functional image, which indicates a tumor or other lesions. In such cases, a user can determine abnormal points by analyzing the functional image. Statistics of the abnormal points are of great significance for pharmacokinetic analysis, tumor metabolic activity analysis, and targeted drug dosage analysis. However, the accuracy of existing abnormal point detection algorithms is relatively low, and there are problems such as missing detection and false detection.

Therefore, it is desirable to provide methods and systems for image processing, which may solve the problems of missing detection and false detection during the abnormal point detection, thereby improving the sensitivity and accuracy of the abnormal point detection.

### SUMMARY

An aspect of the present disclosure relates to a method for image processing. The method may be implemented on a computing device having at least one storage device storing a set of instructions, and at least one processor in communication with the at least one storage device. The method may include, for each stage of at least one stage of a target disease, determining a type of one or more regions of interest (ROIs) corresponding to the stage, generating a first distribution image indicating the distribution of the one or more ROIs corresponding to the stage in a subject by processing a structural image of the subject based on the type of the one or more ROIs, and generating a lesion detection result of the subject by processing a functional image of the subject based on the first distribution image corresponding to the stage.

In some embodiments, the determining a type of one or more ROIs corresponding to the stage may include obtaining a staging criterion relating to the target disease, and determining the type of the one or more ROIs corresponding to the stage based on the staging criterion.

In some embodiments, the staging criterion may include a TNM staging criterion, the type of the one or more ROIs may include at least one of: a local region corresponding to T stage, an adjacent region corresponding to N stage, or a distant region corresponding to M stage.

In some embodiments, the generating a lesion detection result of the subject by processing a functional image of the subject based on the first distribution image corresponding to the stage may include generating a second distribution image indicating the distribution of the one or more ROIs corresponding to the stage in the subject by processing the functional image based on the first distribution image, and generating the lesion detection result of the subject based on the second distribution image.

In some embodiments, the generating the lesion detection result of the subject based on the second distribution image of the one or more ROIs corresponding to the stage may include obtaining a lesion detection standard corresponding to the stage, and generating the lesion detection result of the subject by performing, based on the lesion detection standard, a lesion detection operation on the second distribution image of the one or more ROIs corresponding to the stage.

In some embodiments, the obtaining a lesion detection standard corresponding to the stage may include obtaining at least one reference image of the one or more ROIs corresponding to the stage, each reference image of the at least one reference image including at least one labeled lesion, for each reference image of the at least one reference image, obtaining frequency domain information of the reference image, and determining the lesion detection standard corresponding to the stage based on the at least one labeled lesion and the frequency domain information.

In some embodiments, the generating the lesion detection result of the subject based on the second distribution image of the one or more ROIs corresponding to the stage may include obtaining a lesion detection model corresponding to the stage, and generating the lesion detection result of the subject by performing, using the lesion detection model, lesion detection operation on the second distribution image of the one or more ROIs corresponding to the stage.

In some embodiments, the generating the lesion detection result of the subject based on the second distribution image of the one or more ROIs corresponding to the stage may include determining a target element with the maximum standardized uptake value (SUV) in the one or more ROIs in the second distribution image, determining a first region around the target element, wherein the SUVs of elements in the first region are in a first range determined based on the maximum SUV, determining a second region around the target element, wherein the SUVs of elements in the second region are in a second range determined based on the maximum SUV, and generating the lesion detection result based on the first region and the second region.

In some embodiments, the generating the lesion detection result of the subject based on the second distribution image of the one or more ROIs corresponding to the stage may further include generating a preliminary lesion detection result of the subject based on the second distribution image, and generating the lesion detection result by verifying the preliminary lesion detection result based on at least one of the first distribution image or the structural image.

In some embodiments, the method may further include display the lesion detection result of the subject on the first distribution image.

Another aspect of the present disclosure relates to a system for imaging processing. The system may include at least one storage medium including a set of instructions, and at least one processor in communication with the at least one storage medium. When executing the set of instructions, the at least one processor may be directed to cause the system to perform operations including, for each stage of at least one stage of a target disease, determining a type of one or more regions of interest (ROIs) corresponding to the stage, generating a first distribution image indicating the distribution of the one or more ROIs corresponding to the stage in a subject by processing a structural image of the subject based on the type of the one or more ROIs, and generating a lesion detection result of the subject by processing a functional image of the subject based on the first distribution image corresponding to the stage.

In some embodiments, the determining a type of one or more ROIs corresponding to the stage may include obtaining a staging criterion relating to the target disease, and determining the type of the one or more ROIs corresponding to the stage based on the staging criterion.

In some embodiments, the staging criterion may include a TNM staging criterion, the type of the one or more ROIs may include at least one of: a local region corresponding to T stage, an adjacent region corresponding to N stage, or a distant region corresponding to M stage.

In some embodiments, the generating a lesion detection result of the subject by processing a functional image of the subject based on the first distribution image corresponding to the stage may include generating a second distribution image indicating the distribution of the one or more ROIs corresponding to the stage in the subject by processing the functional image based on the first distribution image, and generating the lesion detection result of the subject based on the second distribution image.

In some embodiments, the generating the lesion detection result of the subject based on the second distribution image of the one or more ROIs corresponding to the stage may include obtaining a lesion detection standard corresponding to the stage, and generating the lesion detection result of the subject by performing, based on the lesion detection standard, a lesion detection operation on the second distribution image of the one or more ROIs corresponding to the stage.

In some embodiments, the obtaining a lesion detection standard corresponding to the stage may include obtaining at least one reference image of the one or more ROIs corresponding to the stage, each reference image of the at least one reference image including at least one labeled lesion, for each reference image of the at least one reference image, obtaining frequency domain information of the reference image, and determining the lesion detection standard corresponding to the stage based on the at least one labeled lesion and the frequency domain information.

In some embodiments, the generating the lesion detection result of the subject based on the second distribution image of the one or more ROIs corresponding to the stage may include obtaining a lesion detection model corresponding to the stage, and generating the lesion detection result of the subject by performing, using the lesion detection model, lesion detection operation on the second distribution image of the one or more ROIs corresponding to the stage.

In some embodiments, the generating the lesion detection result of the subject based on the second distribution image of the one or more ROIs corresponding to the stage may include determining a target element with the maximum standardized uptake value (SUV) in the one or more ROIs in the second distribution image, determining a first region around the target element, wherein the SUVs of elements in the first region are in a first range determined based on the maximum SUV, determining a second region around the target element, wherein the SUVs of elements in the second region are in a second range determined based on the maximum SUV, and generating the lesion detection result based on the first region and the second region.

In some embodiments, the generating the lesion detection result of the subject based on the second distribution image of the one or more ROIs corresponding to the stage may further include generating a preliminary lesion detection result of the subject based on the second distribution image, and generating the lesion detection result by verifying the preliminary lesion detection result based on at least one of the first distribution image or the structural image.

A further aspect of the present disclosure relates to a non-transitory computer readable medium. The non-transitory computer readable medium may include executable instructions that, when executed by at least one processor, direct the at least one processor to perform a method. The method may include for each stage of at least one stage of a target disease, determining a type of one or more regions of interest (ROIs) corresponding to the stage, generating a first distribution image indicating the distribution of the one or more ROIs corresponding to the stage in a subject by processing a structural image of the subject based on the type of the one or more ROIs, and generating a lesion detection result of the subject by processing a functional image of the subject based on the first distribution image corresponding to the stage.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating exemplary hardware and/or software components of an exemplary computing device according to some embodiments of the present disclosure;

FIG. 3 is a block diagram illustrating an exemplary processing device according to some embodiments of the present disclosure;

FIG. 4 is a flowchart illustrating an exemplary process for image processing according to some embodiments of the present disclosure;

FIG. 5 is a flowchart illustrating an exemplary process for performing an abnormal point detection operation on a second distribution image according to some embodiments of the present disclosure;

FIG. 6 is a flowchart illustrating an exemplary process for obtaining an abnormal point detection standard according to some embodiments of the present disclosure;

FIG. 7 is a flowchart illustrating an exemplary process for obtaining an abnormal point detection standard according to some embodiments of the present disclosure;

FIG. 8A is a schematic diagram illustrating an exemplary TNM distribution image according to some embodiments of the present disclosure;

FIG. 8B is a schematic diagram illustrating another exemplary TNM distribution image according to some embodiments of the present disclosure.

FIG. 9 is a flowchart illustrating an exemplary process for generating a lesion detection result according to some embodiments of the present disclosure;

FIG. 10 is a flowchart illustrating an exemplary process for image processing according to some embodiments of the present disclosure; and

FIG. 11 is a flowchart illustrating an exemplary process for determining an image processing model according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

It will be understood that the terms “system,” “engine,” “unit,” “module,” and/or “block” used herein are one method to distinguish different components, elements, parts, sections, or assemblies of different levels in ascending order. However, the terms may be displaced by another expression if they achieve the same purpose.

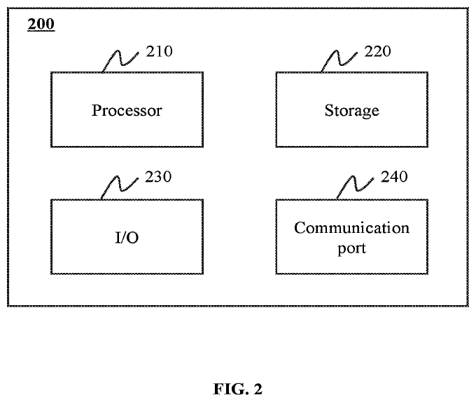

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 210 illustrated in FIG. 2) may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules (or units or blocks) may be included in connected logic components, such as gates and flip-flops, and/or can be included in programmable units, such as programmable gate arrays or processors. The modules (or units or blocks) or computing device functionality described herein may be implemented as software modules (or units or blocks), but may be represented in hardware or firmware. In general, the modules (or units or blocks) described herein refer to logical modules (or units or blocks) that may be combined with other modules (or units or blocks) or divided into sub-modules (or sub-units or sub-blocks) despite their physical organization or storage.

It will be understood that when a unit, engine, module, or block is referred to as being “on,” “connected to,” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items. The term “image” in the present disclosure is used to collectively refer to imaging data (e.g., scan data, projection data) and/or images of various forms, including a two-dimensional (2D) image, a three-dimensional (3D) image, a four-dimensional (4D), etc. The term “pixel” and “voxel” in the present disclosure are used interchangeably to refer to an element of an image. The term “region,” “location,” and “area” in the present disclosure may refer to a location of an anatomical structure shown in the image or an actual location of the anatomical structure existing in or on a target subject's body, since the image may indicate the actual location of a certain anatomical structure existing in or on the target subject's body.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Functional and metabolic imaging may be used to detect distribution of imaging agents (e.g., radionuclide tracers) in a patient. For example, functional images (also referred to as “functional metabolic image”) that reflect a concentration of the imaging agent in different body parts (e.g., organs, tissues, lesions, etc.) of a patient may be obtained by scanning the patient injected with the imaging agent using a single photon emission computed tomography (SPECT) imaging device, a positron emission tomography (PET) imaging device, etc. Elements (e.g., voxels, pixels, etc.) in the functional image may reflect parameters (e.g., a standardized uptake value (SUV)) related to the imaging agent, which may help evaluate the uptake of the imaging agent in different body parts. Merely by way of example, the imaging agent may be taken up abnormally by a lesion (e.g., a tumor) in the patient and form high-concentration points (also referred to as “abnormal points”). Correspondingly, the SUVs corresponding to elements of the lesion in the functional image may be relatively high (e.g., larger than a threshold). A user may identify the abnormal points in the patient based on the functional image. In such cases, lesion detection may be realized, and then a diagnosis result and/or a treatment plan may be determined. It should be noted that “abnormal points in a patient” and “abnormal points in a functional image” may be used interchangeably in this disclosure. The abnormal points may refer to one or more elements (e.g., voxels or pixels) with abnormal SUVs, or a physical region in the patient corresponding to the one or more elements with the abnormal SUVs.

In some embodiments, the abnormal points in the whole body of the patient may be detected based on SUV parameters. Exemplary SUV parameters may include a maximum SUV (SUVmax), an average SUV (SUVmean), a peak SUV (SUVpeak), or the like, or any combination thereof. SUVmax may refer to a maximum value of SUVs in a region. SUVmean may refer to an average value of SUVs in the region. SUVpeak may refer to a maximum value of SUVmeans in a neighborhood of each element in the region. In some embodiments, a threshold corresponding to an SUV parameter may be determined, and a target region having the SUV parameter larger than the threshold may be determined as an abnormal point. In some embodiments, an SUV parameter of a region may be determined based on a reference SUV of other regions. For example, an SUV parameter of region A of a patient may be a ratio of a SUVmean of region A to a SUVmean of region B of the patient. Region B may be a normal region of the patient, such as the liver, aortic blood pool, salivary glands, etc. Determining the SUV parameter based on region B may reduce or eliminate the influence of differences in basal metabolic rates of different populations.

Uptakes of the human body to the imaging agent may also include a physiological uptake, a background uptake, etc. The physiological uptake may refer to the imaging agent may be taken up not only by a lesion, but also by normal parts of the human body. The background uptake may refer to a background uptake by a tissue where the lesion is located. In some embodiments, the SUV corresponding to the physiological uptake, the background uptake, etc. may be close to the SUV of the lesion. For example, the physiological uptakes of the intestinal tract, kidney, etc. to the imaging agent may be relatively high, and the SUVs thereof may be close to the SUV of the lesion, which may affect the accuracy of abnormal point detection. In addition, the human body may have different uptakes (e.g., a position of an abnormal concentration, an intensity of the abnormal concentration) to different types of imaging agents, and different types of lesions may have different uptakes to the same imaging agent, which may also affect the sensitivity and accuracy of the abnormal point detection.

In some embodiments, the abnormal point detection operation may be performed on specific body parts of the patient based on the response evaluation criteria in solid tumors (RECIST) standard, so as to improve the accuracy of the abnormal point detection. However, the abnormal point detection operation performed based on the PERCIST standard may be limited by the PERCIST standard, and may only be performed on several body parts rather than the whole body of the patient. Therefore, the abnormal point detection operation performed based on the PERCIST standard may only be applied in tumor treatment and follow-up, but cannot be applied to scenarios such as tumor burden assessment, pharmacokinetic analysis, drug dose assessment, etc.

The present disclosure may provide systems and methods for image processing. The methods may include, for each stage of at least one stage of a target disease, determining a type of one or more regions of interest (ROIs) corresponding to the stage; generating a first distribution image indicating the distribution of the one or more ROIs corresponding to the stage in a subject by processing a medical image of a first modality (also referred to as a structural image) (e.g., an MR image, a CT image, etc.) of the subject based on the type of the one or more ROIs. The methods may further include generating a second distribution image indicating the distribution of the one or more ROIs corresponding to the stage in the subject by processing a medical image of a second modality (also referred to as a functional image) (e.g., a PET image, a SPECT image, etc.) based on the first distribution image. In some embodiments, the methods may further include performing an abnormal point detection (also referred to as “a lesion detection”) operation on the second distribution image, thus generating a lesion detection result based on the abnormal point detection result. According to the methods provided in the present disclosure, a possible metastasis pathway of the target disease may be reflected in the second distribution image, and then the lesion detection operation may be performed more purposefully based on the second distribution image, which may reduce the problems such as missing detection, false detection, etc., and improve the efficiency and accuracy of the lesion detection.

The present disclosure may also provide systems and methods for image processing. The methods may include obtaining a structural image and a functional image of a subject, and simultaneously generating a distribution image of one or more regions of interest (ROIs) in the subject and a lesion detection image of the subject by processing the structural image and the functional image of the subject using an image processing model. The lesion detection image may indicate a lesion detection result relating to a target disease. In some embodiments, the image processing model may be generated by training a preliminary model based on a plurality of training samples. Each of the plurality of training samples may include a sample structural image of a sample subject having the target disease, a sample functional image of the sample subject, a ground truth distribution image of the one or more ROIs of the sample subject, and a ground truth lesion detection image of the sample subject. When trained based on the plurality of training samples, the preliminary model may learn a type of the one or more ROIs in the ground truth distribution image while learning lesion detection mechanisms, thereby learning a staging criterion relating to the target disease. Then the trained image processing model may be used to process the structural image and the functional image, which may improve the efficiency and accuracy of lesion detection.

For illustration purposes, processing systems and methods of medical data (e.g., medical images) are described in the present disclosure. It should be noted that the description in connection with the data relating to the medical device described below is merely provided as an example, and not intended to limit the scope of the present disclosure. For persons having ordinary skills in the art, the systems and methods disclosed herein may be applied to any other fields that need to perform image processing and/or abnormal point detection operation.

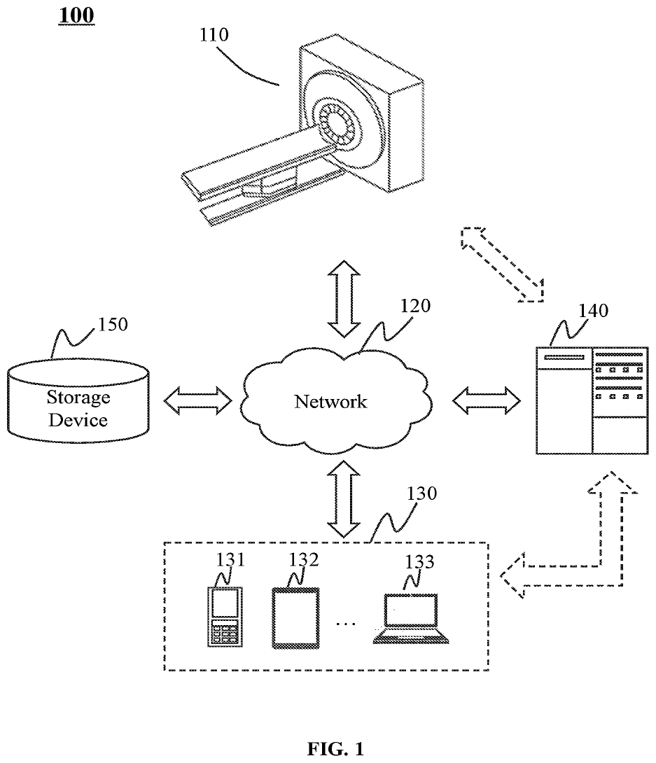

FIG. 1 is a schematic diagram illustrating an exemplary imaging system according to some embodiments of the present disclosure. As illustrated, the imaging system 100 may include an imaging device 110, a network 120, a terminal device 130, a processing device 140, and a storage device 150. The components of the imaging system 100 may be connected in one or more of various ways.

The imaging device 110 may scan a subject located within its detection region and generate or acquire data relating to the subject. In some embodiments, the imaging device 110 may be a medical imaging device for disease diagnostic or research purposes. The medical imaging device may include a single modality imaging device and/or a multi-modality imaging device. The single modality imaging device may include, for example, a computed tomography (CT) imaging device, a magnetic resonance (MR) imaging device, an ultrasound (US) imaging device, a positron emission tomography (PET) device, a single photon emission computed tomography (SPECT) imaging device, or the like, or any combination thereof. The multi-modality imaging device may include, for example, a positron emission tomography-magnetic resonance (PET-MR) imaging device, a single photon emission computed tomography-magnetic resonance imaging (SPECT-MR) imaging device, a computed tomography-positron emission tomography (CT-PET) device, or the like, or any combination thereof. In some embodiments, the data relating to the subject may include scan data, one or more images (e.g., CT images, MR images, PET images, SPECT images, etc.), etc. of the subject. In some embodiments, the imaging device 110 may include an imaging device configured to obtain structural images of the subject, such as the CT imaging device, the MR imaging device, etc. In some embodiments, the imaging device 110 may include an imaging device configured to obtain functional images of the subject, such as the PET imaging device, the SPECT imaging device, etc.

The network 120 may include any suitable network that can facilitate the exchange of information and/or data for the imaging system 100. In some embodiments, one or more components (e.g., the imaging device 110, the terminal device 130, the processing device 140, the storage device 150) of the imaging system 100 may communicate with one or more other components of the medical system 100 via the network 120. For example, the processing device 140 may obtain data relating to the subject from the imaging device 110 through the network 120. As another example, the processing device 140 may obtain a user instruction from the terminal device 130 through the network 120.

The terminal device 130 may include a mobile device 131, a tablet computer 132, a laptop computer 133, or the like, or any combination thereof. In some embodiments, terminal 130 may be part of the processing device 140. In some embodiments, the terminal device 130 may be used to input user instructions, display scan results, or the like. In some embodiments, the terminal device 130 may send prompt information to remind the user.

The processing device 140 may process data and/or information obtained from the imaging device 110, the terminal device 130, the storage device 150, and/or any other components associated with the imaging system 100. In some embodiments, the processing device 140 may obtain the data relating to the subject from the imaging device 110. In some embodiments, the processing device 140 may generate one or more distribution images (e.g., a first distribution image, a second distribution image, etc.) corresponding to a stage of a target disease of the subject by processing data relating to the subject (e.g., a CT image, an MR image, a PET image, a SPECT image, etc.). In some embodiments, the processing device 140 may also generate an abnormal point detection result by performing an abnormal point detection operation on medical image(s) of the subject (e.g., the PET image, the distribution image(s), etc.) according to the methods described in this disclosure.

The storage device 150 may store data and/or instructions. In some embodiments, the storage device 150 may store data obtained from the imaging device 110, the terminal device 130, and/or the processing device 140. In some embodiments, the storage device 150 may store data and/or instructions that the processing device 140 may execute or use to perform exemplary methods described in the present disclosure. In some embodiments, the storage device 150 may be connected to the network 120 to communicate with one or more components (e.g., the imaging device 110, the processing device 140, the terminal device 130) of the imaging system 100. One or more components of the imaging system 100 may access the data or instructions stored in the storage device 150 via the network 120. In some embodiments, the storage device 150 may be directly connected to or communicate with one or more components (e.g., the imaging device 110, the processing device 140, the terminal device 130) of the Imaging system 100. In some embodiments, the storage device 150 may be part of the processing device 140.

FIG. 2 is a schematic diagram illustrating exemplary hardware and/or software components of an exemplary computing device 200 on which the processing device 140 may be implemented according to some embodiments of the present disclosure. As illustrated in FIG. 2, the computing device 200 may include a processor 210, a storage 220, an input/output (I/O) 230, and a communication port 240.

The processor 210 may execute computer instructions (e.g., program code) and, when executing the instructions, cause the processing device 140 to perform functions of the processing device 140 in accordance with techniques described herein. The computer instructions may include, for example, routines, programs, objects, components, data structures, procedures, modules, and functions, which perform particular functions described herein. For example, the processor 210 may process images obtained from the imaging device 110, the terminal device 130, the storage device 150, and/or any other component of the imaging system 100. As another example, the processor 210 may generate a model (e.g., a lesion detection model, an image processing model) used in the present disclosure by training a preliminary model. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors. Thus operations and/or method steps that are performed by one processor as described in the present disclosure may also be jointly or separately performed by the multiple processors. For example, if in the present disclosure the processor of the computing device 200 executes both operation A and operation B, it should be understood that operation A and operation B may also be performed by two or more different processors jointly or separately in the computing device 200 (e.g., a first processor executes operation A and a second processor executes operation B, or the first and second processors jointly execute operations A and B).

The storage 220 may store data/information obtained from the imaging device 110, the terminal device 130, the storage device 150, and/or any other component of the imaging system 100. The storage 220 may be similar to the storage device 150 described in connection with FIG. 1, and the detailed descriptions are not repeated here.

The I/O 230 may input and/or output signals, data, information, etc. In some embodiments, the I/O 230 may allow a user interaction with the processing device 140. In some embodiments, the I/O 230 may include an input device and an output device. Examples of the input device may include a keyboard, a mouse, a touchscreen, a microphone, a sound recording device, or the like, or a combination thereof. Examples of the output device may include a display device, a loudspeaker, a printer, a projector, or the like, or a combination thereof. Examples of the display device may include a liquid crystal display (LCD), a light-emitting diode (LED)-based display, a flat panel display, a curved screen, a television device, a cathode ray tube (CRT), a touchscreen, or the like, or a combination thereof.

The communication port 240 may be connected to a network (e.g., the network 120) to facilitate data communications. The communication port 240 may establish connections between the processing device 140 and the imaging device 110, the terminal device 130, and/or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMAX™ link, a WLAN link, a ZigBee link, a mobile network link (e.g., 3G, 4G, 5G, etc.), or the like, or a combination thereof. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

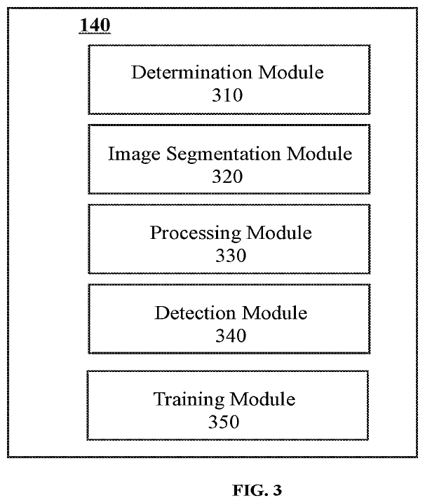

FIG. 3 is a block diagram illustrating an exemplary processing device according to some embodiments of the present disclosure. As illustrated in FIG. 3, the processing device 140 may include a determination module 310, an image segmentation module 320, a processing module 330, a detection module 340, and a training module 350.

The determination module 310 may be configured to, for each stage of at least one stage of a target disease, determine a type of one or more ROIs corresponding to the stage. In some embodiments, to determine the type of one or more ROIs corresponding to the stage, the determination module 310 may be configured to obtaining a staging criterion relating to the target disease, and determine the type of the one or more ROIs corresponding to the stage based on the staging criterion. The staging criterion may include a TNM staging criterion, the type of the one or more ROIs may include at least one of: a local region corresponding to T stage, an adjacent region corresponding to N stage, or a distant region corresponding to M stage.

The image segmentation module 320 may be configured to generate a first distribution image indicating the distribution of the one or more ROIs corresponding to the stage in a subject by processing a structural image of the subject based on the type of the one or more ROIs. The structural image may indicate structural information (e.g., contour information, boundary information, etc.) of different parts (e.g., tissues, organs, etc.) of the subject such that the different parts of the subject may be distinguished based on the structural image. In some embodiments, the image segmentation module 320 may be configured to generate a first segmentation image of the one or more ROIs corresponding to the stage by segmenting the one or more ROIs corresponding to the stage from the structural image. The first segmentation image may be determined as the first distribution image. In some embodiments, each stage of the target disease may correspond to one or more first distribution images. In some embodiments, the one or more ROIs corresponding to at least two stages of the target disease may be displayed in a same first distribution image.

In some embodiments, the image segmentation module 320 may be configured to obtain the first segmentation image of the one or more ROIs corresponding to each stage by performing image segmentation on the structural image using a segmentation model. For example, the segmentation model may be obtained by training a preliminary segmentation model based on a training sample set. The preliminary segmentation model may include a machine learning model. The image segmentation module 320 may obtain the segmentation model and generate the first segmentation image by performing image segmentation on the structural image using the segmentation model.

The processing module 330 may be configured to generate a second distribution image indicating the distribution of the one or more ROIs corresponding to the stage in the subject by processing a functional image based on the first distribution image. Elements (e.g., voxels, pixels, etc.) in the functional image may reflect the uptake of corresponding physical points in the subject to the imaging agent. Exemplary functional images may include a PET image, an SPECT image, etc.

In some embodiments, to determine the second distribution image corresponding to each stage, the processing module 330 may be configured to determine the one or more ROIs (i.e., one or more image regions corresponding to the one or more ROIs of the stage) by processing the functional image based on the first distribution image corresponding to each stage. In some embodiments, the processing module 330 may perform image registration on the first distribution image (or the structural image) and the functional image, and determine the one or more ROIs in the registered functional image based on the one or more ROIs in the first distribution image. In some embodiments, the processing module 330 may perform image fusion on the first distribution image (or the structural image) and the functional image, and determine the one or more ROIs in the fused image. Further, the processing module 330 may determine the second distribution image corresponding to each stage based on the one or more ROIs in the fused image. For example, the processing module 330 may perform image segmentation on the functional image, and obtain a segmentation result including the one or more ROIs as the second distribution image. As another example, the processing module 330 may directly determine the functional image by outlining the one or more ROIs as the second distribution image.

The detection module 340 may be configured to generate a lesion detection result of the subject based on the second distribution image. In some embodiments, for each stage in the one or more stages, the detection module 340 may be configured to obtain an abnormal point detection standard (also referred to as “a lesion detection standard”) corresponding to the stage. Further, the detection module 340 may be configured to perform an abnormal point detection operation (also referred to as “a lesion detection operation”) on the second distribution image corresponding to the stage based on the abnormal point detection standard.

The abnormal point detection standard may specify rules for determining whether there is an abnormal point in the second distribution image. In some embodiments, the abnormal point detection standard may be a standard manually determined by the user. In some embodiments, the abnormal point detection standard corresponding to the stage can be determined based on frequency domain information of the functional image. In some embodiments, the abnormal point detection standard corresponding to the stage may be determined based on an abnormal point detection model (also referred to as “a lesion detection model”). In some embodiments, the user may input the abnormal point detection standard through an input device (e.g., the terminal device 130 in FIG. 1), and the detection module 340 may obtain the abnormal point detection standard from the input device. In some embodiments, the abnormal point detection standard may be obtained from a storage device (e.g., the storage device 150) disclosed elsewhere in this disclosure. The detection module 340 may obtain information relating to the stage of the target disease (e.g., a name, a serial number of the target disease and/or the stage, etc.), and obtain the abnormal point detection standard from the storage device 150 based on the information relating to the stage.

In some embodiments, to perform the abnormal point detection operation on the second distribution image corresponding to the stage, the detection module 340 may determine a target region in the second distribution image. For example, the detection module 340 may determine the target region based on SUV parameter(s). Further, the detection module 340 may determine whether the target region includes an abnormal point based on the abnormal point detection standard.

In some embodiments, the detection module 340 may generate the abnormal point detection result by performing the abnormal point detection operation based on two or more regions in the second distribution image. For example, the detection module 340 may determine a target element with the SUVmax in the one or more ROIs in the second distribution image. Further, the detection module 340 may determine a first region around the target element, wherein the SUVs of elements in the first region are in a first range determined based on the maximum SUV. Further, the detection module 340 may determine a second region around the target element. The SUVs of elements in the second region may be in a second range determined based on the maximum SUV. Furthermore, the detection module 340 may generate the abnormal point detection result based on the first region and the second region.

In some embodiments, the detection module 340 may obtain an abnormal point detection model corresponding to each stage, and perform the abnormal point detection operation on the second distribution image corresponding to each stage using the abnormal point detection model.

In some embodiments, the detection module 340 may obtain an image processing model, and simultaneously generate a distribution image of one or more ROIs in the subject and a lesion detection image of the subject by processing the structural image and the functional image of the subject using the image processing model. The lesion detection image may indicate the abnormal point detection result relating to the target disease.

The training module 350 may be configured to generate a model used in the present disclosure.

In some embodiments, the training module 350 may be configured to generate an abnormal point detection model (also referred to as “a lesion detection model”). For example, the training module 350 may obtain a training sample set. The training sample set may include a plurality of sample distribution images of the one or more ROIs corresponding to the stage. Each sample distribution image of the plurality of sample distribution images may include at least one labeled abnormal point. Further, the training module 350 may obtain the abnormal point detection model by training the preliminary model based on the training sample set.

In some embodiments, the training module 350 may be configured to generate an image processing model. For example, the training module 350 may obtain a plurality of training samples. Each training sample may include a sample structural image of a sample subject having the target disease, a sample functional image of the sample subject, a ground truth distribution image of the one or more ROIs of the sample subject, and a ground truth lesion detection image of the sample subject. In some embodiments, to obtain the ground truth distribution image, the training module 350 may obtain a staging criterion relating to the target disease, and determine a type of one or more ROIs corresponding to the stage based on the staging criterion. Further, the training module 350 may determine the ground truth distribution image of each training sample based on the type of the one or more ROIs. In some embodiments, to obtain the ground truth lesion detection image, the training module 350 may generate a sample distribution image of the one or more ROIs by processing the sample functional image based on the ground truth distribution image. Further, the training module 350 may generate the ground truth lesion detection image based on the sample distribution image. For example, training module 350 may generate the ground truth lesion detection image based on a lesion detection standard. In some embodiments, the training module 350 may generate the ground truth lesion detection image based on a lesion detection model. For example, the training module 350 may obtain a lesion detection model corresponding to the target disease. Further, the training module 350 may generate the ground truth lesion detection image by performing, using the lesion detection model, a lesion detection operation on the sample distribution image. In some embodiments, the ground truth distribution image and/or the ground truth lesion detection image may be generated manually.

Further, the training module 350 may generate the image processing model by training a preliminary model using the plurality of training samples.

It should be noted that the above descriptions of the processing device 140 and the modules are provided for the purposes of illustration, and not intended to limit the scope of the present disclosure. For persons having ordinary skills in the art, various modifications and changes in the forms and details of the application of the above method and system may occur without departing from the principles of the present disclosure. For example, the determination module 310, the image segmentation module 320, the processing module 330, the detection module 340, and the training module 350 may be different modules in one system, or one module that may realize the functions of the two or more modules. As another example, the processing device 140 may further include a display module configured to display an abnormal point detection result. As a further example, the processing device 140 may further include a verification module configured to generate the lesion detection result by verifying a preliminary lesion detection result. As a further example, the detection module 340 may be omitted. In some embodiments, the training module 350 and other modules described above may be implemented on different computing devices. Merely by way of example, the training module 350 may be implemented on a computing device of a vendor of the machine learning model(s) used for image processing, while the other modules described above may be implemented on a computing device of a user of the machine learning model(s). However, those variations and modifications also fall within the scope of the present disclosure.

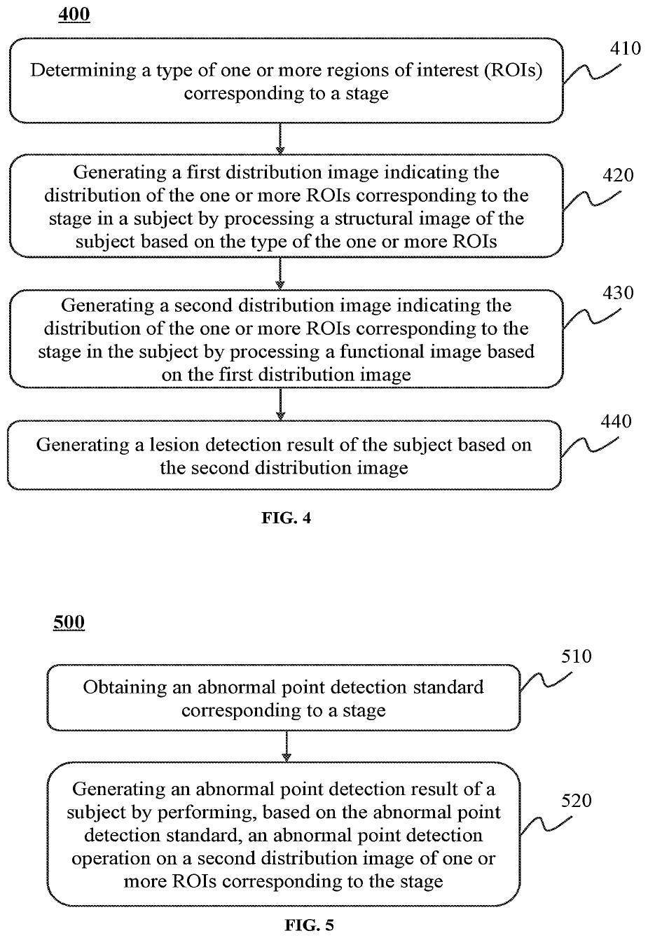

FIG. 4 is a flowchart illustrating an exemplary process for image processing according to some embodiments of the present disclosure. In some embodiments, at least part of process 400 may be performed by the processing device 140 (implemented in, for example, the computing device 200 shown in FIG. 2). For example, the process 400 may be stored in a storage device (e.g., the storage device 150, the storage 220) in the form of instructions (e.g., an application), and invoked and/or executed by the processing device 140 (e.g., the processor 210 illustrated in FIG. 2, the one or more modules illustrated in FIG. 3). The operations of the illustrated process presented below are intended to be illustrative. In some embodiments, the process 400 may be accomplished with one or more additional operations not described, and/or without one or more of the operations discussed. Additionally, the order in which the operations of the process 400 as illustrated in FIG. 4 and described below is not intended to be limiting. In some embodiments, the process 400 may be performed for each stage of at least one stage of a target disease.

In 410, the processing device 140 may determine a type of one or more ROIs corresponding to the stage. In some embodiments, operation 410 may be performed by the determination module 310.

In some embodiments, the target disease may have different development phases, and the different development phases may correspond to different stages. Each stage of the target disease may correspond to one or more ROIs of specific types. The type of the one or more ROIs may indicate regions (or body parts) where the target disease at the current stage is probably distributed in the subject. In some embodiments, to determine the type of one or more ROIs corresponding to the stage of the target disease, the processing device 140 may obtain a staging criterion relating to the target disease, and determine the type of the one or more ROIs corresponding to the stage based on the staging criterion. The staging criterion may be a medical standard or guideline for determining the stage of the target disease and the type of the one or more ROIs corresponding to the stage.

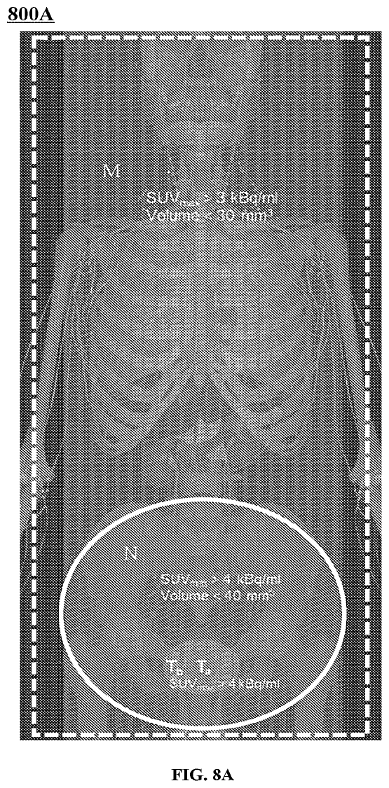

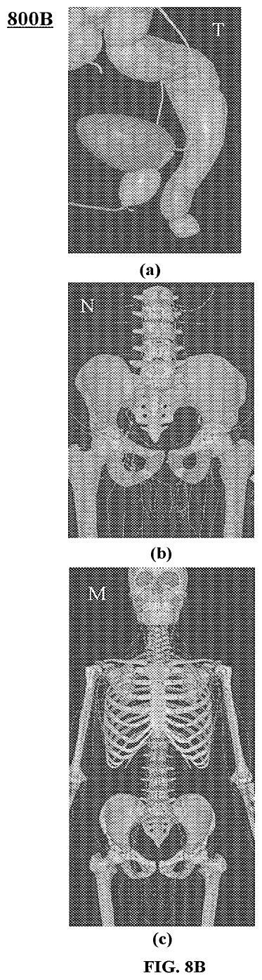

Taking a tumor as an example, sizes of the tumor at different stages may be different, and the tumor may gradually metastasize to different parts of the subject. In such cases, the staging criterion used to stage the tumor may be determined according to the size, the metastasis pathway, etc. of the tumor. For example, the staging criterion relating to the tumor may include a tumor node metastasis (TNM) staging criterion, which stages the tumor into a tumor (T) stage, a node (N) stage, and a metastasis (M) stage. In the T stage, the tumor may be distributed in a local region (e.g., a primary lesion); in the N stage, the tumor may metastasize to lymph nodes in an adjacent region; and in the M stage, the tumor may metastasize to distant region. The type of the one or more ROIs corresponding to each stage may also be specified in the TNM staging criterion. For example, the types of the one or more ROIs may include a local region corresponding to T stage, an adjacent region corresponding to N stage, or a distant region corresponding to M stage, etc. Merely by way of example, as illustrated in (a)-(b) of FIG. 8B, the type of the one or more ROIs corresponding to the T stage of a prostate cancer may include a region where the seminal vesicle line around the prostate is located and/or a region where the prostate cancer breaches a capsule of the prostate, the type of the one or more ROIs corresponding to the N stage may include a region where the pelvic lymph nodes and/or adjacent bones are located, and the type of the one or more ROIs corresponding to the M stage may include a region where the skull, the spine, etc. are located.

In some embodiments, a stage may further include one or more sub-stages, which may indicate different periods of the tumor in the stage. For example, in the T stage, the patient may be in a T0 stage if there is no evidence of a primary tumor; and as the tumor volume increases and/or a metastasis range of the tumor in adjacent tissues increases, the T stage may be further divided into T1-T4 stages. As another example, in the N stage, the patient may be in an NO stage if there is no evidence of lymph node metastasis in a surrounding region; and as a range of the lymph node metastasis increases, the N stage may be further divided into N1-N3 stages. In some embodiments, the type of the one or more ROIs corresponding to each sub-stage in the one or more sub-stages may also be determined based on the staging criterion.

In some embodiments, since different types of target diseases may have different metastasis pathways in a subject, different types of target diseases may have different staging criterion. Correspondingly, different target diseases may have different types of one or more ROIs corresponding to the same stage. In some embodiments, the staging criterion of the target disease may be determined based on sample data. For example, sample data of a target disease may be obtained and metastasis pathways of the target disease in a plurality of sample subjects may be determined based on the sample data. Stages of the target disease and a type of one or more ROIs corresponding to each stage may be determined based on the metastasis pathways in the sample data. Then the staging criterion of the target disease may be determined.

In some embodiments, a user may input the staging criterion through an input device (e.g., the terminal device 130 in FIG. 1), and the processing device 140 may obtain the staging criterion from the input device. In some embodiments, the processing device 140 may obtain the staging criterion from a storage device (e.g., the storage device 150) disclosed elsewhere in this disclosure. For example, the staging criterion corresponding to different target diseases may be stored in storage device 150. The processing device 140 may obtain information relating to the target disease (e.g., a name, a serial number of the target disease input by the user), and obtain a corresponding staging criterion from the storage device 150 based on the information relating to the target disease.

In 420, the processing device 140 may generate a first distribution image indicating the distribution of the one or more ROIs corresponding to the stage in a subject by processing a structural image of the subject based on the type of the one or more ROIs. In some embodiments, operation 420 may be performed by the image segmentation module 320.

The structural image may indicate structural information (e.g., contour information, boundary information, etc.) of different parts (e.g., tissues, organs, etc.) of the subject such that the different parts of the subject may be distinguished based on the structural image. Exemplary structural images may include a CT image, an MR image, an ultrasound image, etc. In some embodiments, the structural image may be generated by scanning the subject (e.g., a patient) using a first imaging device (e.g., the imaging device 110 illustrated in FIG. 1). Exemplary first imaging devices may include a CT imaging device, an MR imaging device, an ultrasound imaging device, a PET-MRI imaging device, an SPECT-MRI imaging device, a PET-CT imaging device, or the like, or any combination thereof. In some embodiments, the structural image may include a two-dimensional image, a three-dimensional image, or the like, or any combination thereof. For example, the structural image may include a two-dimensional image including a plurality of pixels. As another example, the structural image may include a three-dimensional image including a plurality of voxels. Each pixel or voxel may correspond to a physical point in the subject.

In some embodiments, the structural image may be obtained directly from the first imaging device. In some embodiments, the structural image may be obtained from a storage device (e.g., the storage device 150) disclosed elsewhere in the disclosure. For example, the structural image generated by the imaging device 110 may be transmitted and stored in the storage device 150. The processing device 140 may obtain the structural image from the storage device 150.

In some embodiments, the target disease may have one or more stages. A distribution image of the stage may graphically show a possible region (or body part) where relevant lesions of the target disease at a certain stage are distributed in the subject or in an image of the subject. That is, the distribution image of the stage may graphically show a distribution the one or more ROIs corresponding to the stage in the subject or in the image of the subject.

In some embodiments, a first segmentation image of the one or more ROIs corresponding to the stage may be generated by segmenting the one or more ROIs corresponding to the stage from the structural image. The first segmentation image may be determined as the first distribution image. In some embodiments, the first distribution image and the first segmentation image may be used interchangeably. In some embodiments, the processing device 140 may determine TNM distribution images corresponding to the TNM stages. The TNM distribution images may graphically show possible regions (or body parts) where the target disease at each stage is distributed in the subject and indicate a metastatic pathway of the target disease. Taking the prostate cancer as an example, the one or more ROIs corresponding to the T stage of the prostate cancer may include a region where the seminal vesicle line around the prostate is located and/or a region where the prostate cancer breaches a capsule of the prostate. The structural image (e.g., a CT image, an MR image, an ultrasound image, etc.) of the subject may be obtained by scanning the subject. The structural image may illustrate boundaries between different parts of the subject. Further, the processing device 140 may obtain a first distribution image including the seminal vesicle line and the capsule of the prostate by segmenting the seminal vesicles and the capsule of the prostate from the structural image. The first distribution image may be used as a T distribution image corresponding to the T stage of the prostate cancer. In some embodiments, segmentations of the seminal vesicle line and the capsule may be performed simultaneously or separately. For example, a segmentation image of the seminal vesicle line and a segmentation image of the capsule may be obtained respectively by segmenting the structural image. Further, the T distribution image corresponding to the T stage of the prostate cancer may be obtained by combining the two segmentation images. In some embodiments, segmenting the one or more ROIs may refer to displaying only the one or more ROIs in the first segmentation image. In some embodiments, segmenting the one or more ROIs may refer to displaying the one or more ROIs and regions other than the one or more ROIs differently in the first segmentation image. For example, the first segmentation image may be generated by delineating or marking the one or more ROIs in the structural image, and in the first segmentation image, there is a boundary between the one or more ROIs and the regions other than the one or more ROIs.

In some embodiments, the processing device 140 may obtain the first segmentation image of the one or more ROIs corresponding to each stage by performing image segmentation on the structural image using a segmentation model. For example, the segmentation model may be obtained by training a preliminary segmentation model based on a training sample set. The preliminary segmentation model may include a machine learning model. In some embodiments, each stage of the target disease may correspond to a segmentation model. For example, for each stage, a segmentation model for obtaining a segmentation image of the one or more ROIs corresponding to the stage may be obtained. In some embodiments, two or more stages of the target disease may correspond to a same segmentation model. For example, for a lung cancer, a segmentation model for obtaining a segmentation image of the one or more ROIs corresponding to the TNM stages of the lung cancer may be obtained. A structural image of a patient having the lung cancer may be input into the segmentation model, and a segmentation image including the one or more ROIs of T stage, the one or more ROIs of N stage, and the one or more ROIs of M stage may be output by the segmentation model. Optionally, the structural image of the patient having the lung cancer and parameters relating to the T stage (e.g., text or numbers indicating the T stage) may be input into the segmentation model such that a T distribution image corresponding to the T stage may be obtained.

In some embodiments, each stage of the target disease may correspond to one or more first distribution images. For example, for the T stage of the prostate cancer, a first distribution image corresponding to the T stage may be obtained by performing image segmentation on the structural image. The first distribution image corresponding to the T stage may include the seminal vesicle line around the prostate and/or the capsule. Similarly, the first distribution image corresponding to the N stage may include pelvic lymph nodes and/or adjacent bones, and the first distribution image corresponding to the M stage may include skulls, spines, or the like. In some embodiments, the one or more ROIs corresponding to at least two stages of the target disease may be displayed in a same first distribution image. For example, the one or more ROIs corresponding to the T stage and the M stage of the target disease may be presented in the same first distribution image. As another example, the one or more ROIs corresponding to all stages of the target disease may be segmented simultaneously and presented in the same first distribution image.

In 430, the processing device 140 may generate a second distribution image indicating the distribution of the one or more ROIs corresponding to the stage in the subject by processing a functional image based on the first distribution image. In some embodiments, operation 430 may be performed by the processing module 330.

Elements (e.g., voxels, pixels, etc.) in the functional image may reflect the uptake of corresponding physical points in the subject to the imaging agent. Exemplary functional images may include a PET image, an SPECT image, etc. In some embodiments, the functional image may be generated by scanning the subject (e.g., a patient) using a second imaging device (e.g., the imaging device 110 illustrated in FIG. 1). For example, a PET image may be generated by scanning the subject using a PET scanning device and designated as the functional image. As another example, an SUV of each element in the PET image may be determined based on data attributes (e.g., a gray value) of the element in the PET image. In such cases, an SUV image may be obtained as the functional image. As another example, a PET image indicating SUVs of a partial region of the subject may be obtained as a functional image by determining the SUVs of the partial region. In some embodiments, the second imaging device and the first imaging device described above may be a same imaging device or different imaging devices. The obtaining method of the functional image may be similar to that of the structural image, which is repeated herein.

In some embodiments, the functional image may include limited structural information of different parts of the subject, and it is difficult to obtain the second distribution image corresponding to each stage by determining the one or more ROIs corresponding to each stage directly on the functional image. In such cases, the first distribution image may be generated based on the structural image, and the second distribution image corresponding to each stage may be generated by processing the functional image based on the first distribution image. Similar to the first distribution image, the second distribution image may also graphically show possible regions (or body parts) where relevant lesions of the target disease at a certain stage are distributed in the subject or in an image of the subject. A difference between the first distribution image and the second distribution image may include that the first distribution image is determined based on the structural image, and the second distribution image is determined based on the functional image and the first distribution image. In some embodiments, the second distribution image may also be referred to as a second segmentation image of the one or more ROIs corresponding to the stage. The second distribution image and the second segmentation image may be used interchangeably in the present disclosure. In some embodiments, the structural image and the functional image may be images of the subject acquired under a same scanning condition. The same scanning condition may include a same time, a same physiological phase (e.g., a respiratory phase, a cardiac phase, etc.), etc.

In some embodiments, to determine the second distribution image corresponding to each stage, the processing device 140 may determine the one or more ROIs (i.e., one or more image regions corresponding to the one or more ROIs of the stage) by processing the functional image based on the first distribution image corresponding to each stage. In some embodiments, the processing device 140 may perform image registration on the first distribution image (or the structural image) and the functional image, and determine the one or more ROIs in the registered functional image based on the one or more ROIs in the first distribution image. For example, the one or more ROIs may be delineated or segmented from the registered functional image based on the first distribution image. In some embodiments, the processing device 140 may perform image fusion on the first distribution image (or the structural image) and the functional image, and determine the one or more ROIs in the fused image. Further, the processing device 140 may determine the second distribution image corresponding to each stage based on the one or more ROIs in the fused image. For example, the processing device 140 may perform image segmentation on the functional image, and obtain a segmentation result including the one or more ROIs as the second distribution image. As another example, the processing device 140 may directly determine the functional image by outlining the one or more ROIs as the second distribution image.

In some embodiments, the possible regions (or body parts) where the target disease in each stage is distributed may be determined by determining the type of the one or more ROIs corresponding to the stage of the target disease, such that the possible metastasis pathway of the target disease may be determined. Further, the metastasis pathway of the target disease may be reflected in the first distribution image. Furthermore, the second distribution image may be obtained based on the first distribution image and the functional image, such that the metastasis pathway of the target disease may be displayed in the functional image intuitively, which may solve the problem that it is difficult to determine the one or more ROIs corresponding to each stage directly on the functional image due to the limited structural information included in the functional image. In abnormal point detection (also referred to as “a lesion detection”), the abnormal point detection operation may be performed based on the metastasis pathway reflected in the second distribution image, such that the abnormal point detection operation may be performed more purposefully, which may reduce the problems such as missing detection, false detection, etc., and improve the efficiency and accuracy of the abnormal point detection.

In addition, the region where the target disease is distributed at a current stage may be distinguished from other regions of the subject by generating the second distribution image of the stage. For example, the second distribution image of the stage may only include the region where the one or more ROIs corresponding to the stage are located, and regions other than the one or more ROIs may not be displayed in the second distribution image. As another example, the second distribution image may include all regions of the subject, and the region where the one or more ROIs are located may be displayed differently from other regions (e.g., there is a boundary between the one or more ROIs and other regions). In such cases, the second distribution image may be used to distinguish the region where the target disease is distributed from other regions of the subject, which may reduce or eliminate the influence of physiological uptake in other regions on the abnormal point detection, thereby avoiding missing detection, and improving the sensitivity and accuracy of the abnormal point detection. In some embodiments, the second distribution image may also be used for medical analysis such as a tumor burden analysis, a radiomics analysis, and gene mutation identification of tumor metastases, which may provide reference information for the above medical analysis, thereby improving the efficiency and accuracy of medical analysis.

In 440, the processing device 140 may generate a lesion detection result of the subject based on the second distribution image. In some embodiments, operation 440 may be performed by the detection module 340.

A lesion may include any damage or abnormal change in the tissue of the subject, usually caused by disease or trauma. The lesion detection result may include any information relating to the lesion of the subject, such as location information (e.g., an organ where the lesion is located, a coordinate position of the lesion in the subject, etc.), size information, shape information, severity, or the like, or any combination thereof. In some embodiments, the lesion detection result may be generated by identifying a lesion in the second distribution image or the functional image. For example, a region where the lesion is located may be determined by delineating, segmenting, or highlighting the lesion in the second distribution image or functional image. In some embodiments, the lesion detection result may include information relating to abnormal points of the subject. The abnormal point may refer to a high-concentration point in the subject that has an abnormal uptake of the imaging agent. In some embodiments, the abnormal point may have a high signal in the functional image of the subject. For example, the SUV of the element (e.g., a voxel or a pixel) corresponding to the abnormal point in the functional image may be larger than a threshold. In some embodiments, the abnormal points may refer to one or more elements (e.g., voxels or pixels) with abnormal SUVs, or a physical region in the patient corresponding to the one or more elements with the abnormal SUVs. In some embodiments, the abnormal point may indicate the region where the lesion is located.

In some embodiments, for each stage in the one or more stages, an abnormal point detection standard corresponding to the stage may be obtained. Further, the abnormal point detection operation may be performed on the second distribution image corresponding to the stage based on the abnormal point detection standard. In some embodiments, the abnormal point detection standard may relate to SUV parameters, a volume, a shape, a boundary feature, a histogram distribution, a texture feature, frequency domain information, etc. of the abnormal point. More descriptions regarding performing the abnormal point detection operation on the second distribution image may be found elsewhere in the present disclosure. See, e.g., FIGS. 5-7 and descriptions thereof.

It should be noted that the above description of the process 400 is merely provided for the purposes of illustration, and not intended to limit the scope of the present disclosure. For persons having ordinary skills in the art, multiple variations or modifications may be made under the teachings of the present disclosure. In some embodiments, the process 400 may include one or more additional operations or one or more operations of the process 400 may be omitted.

In some embodiments, operation 440 may be omitted. For example, the processing device 140 may obtain the second distribution image corresponding to the stage by processing medical images according to the method described in operations 410-430. The second distribution image may be used for display and/or for further analysis. In some embodiments, operation 430 and operation 440 may be omitted. For example, the processing device 140 may determine the abnormal point detection result by performing the abnormal point detection operation on the functional image directly. Merely by way of example, the processing device 140 may determine the abnormal point detection result by performing the abnormal point detection operation on the functional image based on an abnormal point detection standard. The abnormal point detection standard may include a standard for the whole functional image, or include different standards for each region of several regions (e.g., limbs, torso, head, etc.) of the functional image. Further, the processing device 140 may process the functional image including the abnormal point detection result based on the first distribution image. For example, the processing device 140 may generate a functional image including one or more ROIs and the abnormal point detection result by delineating or segmenting, based on the first distribution image, one or more ROIs in the functional image including the abnormal point detection result. As another example, the processing device 140 may generate a structural image including one or more ROIs and the abnormal point detection result by marking abnormal points in the structural image including the one or more ROIs based on the abnormal point detection results. As another example, the processing device 140 may also generate a functional image including the one or more ROIs and the abnormal point detection result by fusing the first distribution image with the functional image including the abnormal point detection result. The processed structural image and/or functional image may be used for display and/or further analysis. For example, a user may determine whether there is a target disease on the subject, a stage of the target disease, etc. based on the processed structural image and/or functional image.

In some embodiments, the process 400 may also include an image display operation. For example, in the image display operation, the abnormal point detection result may be displayed. As another example, in the image display operation, at least two of the structural image, the functional image, the first distribution image, and the second distribution image may be displayed. As another example, at least two of the structural image, the functional image, the first distribution image, the second distribution image, and the abnormal point detection result may be displayed separately or in combination (e.g., the abnormal point detection result, the first distribution image, and the structural image may be fused for display). In some embodiments, the process 400 may further include an operation of determining a diagnosis and treatment result based on the abnormal point detection result.

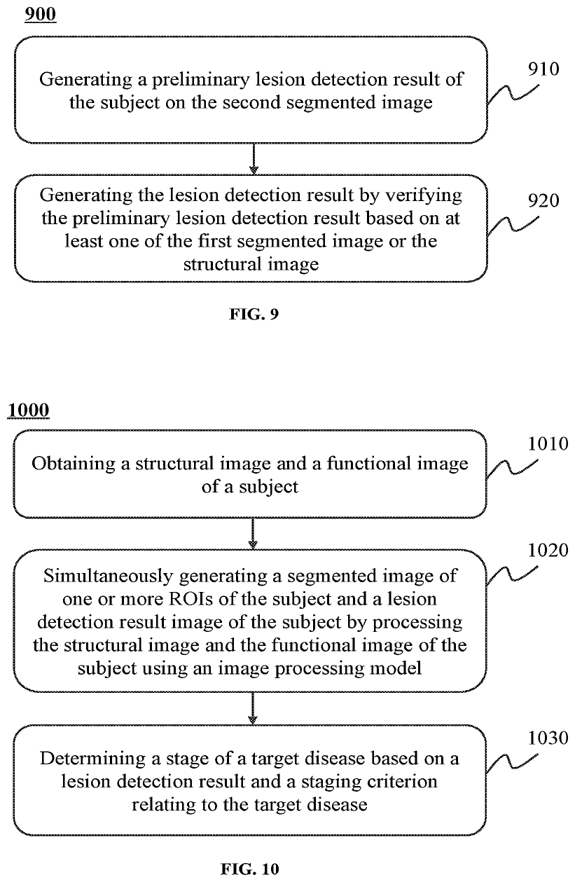

In some embodiments, the process 400 may also include an operation of verifying the lesion detection result. For example, a preliminary lesion detection result may be determined based on the method described in operations 410-440. Further, the preliminary lesion detection result may be verified based on the first distribution image or the structural image. More descriptions regarding verifying the lesion detection result may be found elsewhere in the present disclosure. See, e.g., FIG. 9 and descriptions thereof.

In some embodiments, operation 430 and operation 440 may be combined into one operation. Merely by way of example, the processing device 140 may generate a first distribution image according to the method described in operation 420, and the first distribution image may be used for determining abnormal points. For example, in the abnormal point detection operation, for each stage of the target disease, the processing device 140 may generate the second distribution image by processing the functional image based on the first distribution image. Further, the processing device 140 may generate a lesion detection result by performing an abnormal point detection operation on the second distribution image.

In some embodiments, operation 420 and operation 430 may be combined into one operation. Merely by way of example, the medical image may include a multi-modality medical image (e.g., a PET-CT image, a PET-MR image, an SPECT-MR image, etc.), the multi-modality medical image may include structural information of the subject and reflect the uptake of the subject to the imaging agent. The processing device 140 may directly generate the second distribution image by processing the multi-modality medical image. The second distribution image may be used for abnormal point detection.

The process 400 is illustrated by taking a tumor as an example. It should be noted that the image processing method described in the present disclosure may also be used to detect abnormal points in target diseases other than tumors. Merely by way of example, for a target disease other than a tumor, the functional image of the subject may be obtained by scanning the subject with the beta amyloid protein as an imaging agent. As specified in the TNM staging criterion corresponding to such target disease, the one or more ROIs corresponding to the T stage may include the brain, the one or more ROIs corresponding to the N stage may be empty, and the one or more ROIs corresponding to the M stage may include other parts of the body.

In some embodiments, the target disease may include a plurality of stages. The processing device 140 may generate first distribution images, second distribution images, and abnormal point detection results of the plurality of stages by performing the process 400 for the plurality of stages, respectively. In some embodiments, distribution images of different stages may be generated simultaneously. For example, a first mixture distribution image may be generated by processing a structural image using a segmentation model capable of segmenting the one or more ROIs corresponding to the T stage and the one or more ROIs corresponding to the N stage from the structural image. The first mixture distribution image simultaneously indicates a distribution of the one or more ROIs corresponding to the T stage and a distribution of the one or more ROIs corresponding to the N stage in the subject. In some embodiments, distribution images of different stages may be generated separately and combined into a mixture distribution image. For example, a second distribution image of T stage and a second distribution image of N stage may be generated. Then the second distribution images may be combined to generate a second mixture distribution image. Optionally, an abnormal point detection operation may be performed on the one or more ROIs corresponding to T stage in the second mixture distribution image based on the abnormal point detection standard corresponding to T stage, and an abnormal point detection operation may be performed on the one or more ROIs corresponding to N stage in the second mixture distribution image based on the abnormal point detection standard corresponding to N stage. In such cases, an abnormal point detection result corresponding to the T stage and the N stage may be generated.

FIG. 5 is a flowchart illustrating an exemplary process for performing an abnormal point detection operation on a second distribution image according to some embodiments of the present disclosure. In some embodiments, operation 440 in the process 400 may be performed according to the process 500.

In 510, the processing device 140 may obtain an abnormal point detection standard (also referred to as “a lesion detection standard”) corresponding to a stage.

The abnormal point detection standard may specify rules for determining whether there is an abnormal point in the second distribution image. In some embodiments, the processing device 140 may determine a target region in the second distribution image. Further, the processing device 140 may determine whether the target region includes an abnormal point based on the abnormal point detection standard. In some embodiments, the abnormal point detection standard may relate to SUV parameter(s), a volume, a shape, a boundary feature, a histogram distribution, a texture feature, etc., of the abnormal point. The SUV parameter(s) of the abnormal point may include an SUVmax, an SUVmean, an SUVpeak, a ratio of an SUV parameter to a reference SUV, or the like, or any combination thereof. The standard relating to the SUV parameter(s) of the abnormal point may specify that the SUV parameter of the target region has a specific relationship with an SUV threshold (e.g., larger than the SUV threshold). The standard relating to the volume of the abnormal point may specify that the volume of the target region has a specific relationship with a volume threshold (e.g., smaller than the volume threshold). The standard relating to the shape, the boundary feature, the histogram distribution, the texture feature, etc. of the abnormal point may specify that the shape, the boundary feature, the histogram distribution, the texture feature, etc., of the target region satisfy predetermined conditions.

In some embodiments, the abnormal point detection standard corresponding to the stage may relate to parameters such as a type of the imaging agent taken in by the subject, a type of the target disease, the stage of the target disease, the individual information of the subject (e.g., a height, a weight, a blood sugar level, age, gender, etc.), etc. For example, a same subject may have different uptakes to different imaging agents. In such cases, different imaging agents may correspond to different abnormal point detection standards. As another example, different target diseases may have different uptakes to the same imaging agent. In such cases, different target diseases may correspond to different abnormal point detection standards. As another example, ROIs in different stages of the target disease may have different uptakes to the same imaging agent. Volumes of lesions in the ROIs in different stages may be different. In such cases, different stages may correspond to different abnormal point detection standards. Merely by way of example, in an abnormal point detection operation performed on the second distribution image corresponding to the T stage of a prostate cancer, the abnormal point detection standard may include that the SUVmax of the target region is larger than 6 kBq/ml. In an abnormal point detection operation performed on the second distribution image corresponding to the N stage of the prostate cancer, the abnormal point detection standard may include that the SUVmax of the target region is larger than 4 kBq/ml, and a volume of the target region has a specific relationship with a volume threshold (e.g., smaller than 40 mm³). The volume threshold may be determined such that an abnormal point may be distinguished from the physiological uptake and/or the background uptake, which may reduce false detection of the abnormal point, thereby improving the accuracy of the abnormal point detection. As another example, the individual information of the subject (e.g., a height, a weight, a blood sugar level, age, gender, etc.) may affect the uptake of the subject to the imaging agent. In such cases, the abnormal point detection standards corresponding to different subjects may be different.

In some embodiments, the abnormal point detection standard corresponding to each stage determined based on the one or more parameters may have strong specificity, which may reduce the influence of individual factors of the subject on the abnormal point detection result, and improve the sensitivity and accuracy of the abnormal point detection. Merely by way of example, prostate specific membrane antigen (PSMA) may be used as a specific sign of the prostate cancer. A specific imaging agent may be used and a specific abnormal point detection standard may be determined for the PSMA of the prostate cancer, thereby improving the sensitivity and accuracy of abnormal point detection of the prostate cancer. It should be understood that the above-mentioned embodiments are for the purpose of illustration and description only and are not intended to limit the scope of the present disclosure. In some embodiments, the abnormal point detection standards corresponding to subjects with different characteristics may also be the same. For example, the abnormal point detection standards corresponding to different imaging agents may be the same. The user may determine the abnormal point detection standards without referring to the types of the imaging agents, which may improve the convenience and efficiency of the abnormal point detection operation.

In some embodiments, the abnormal point detection standard may be a standard manually determined by the user. For example, the abnormal point detection standard may be empirical data determined based on analysis of historical data relating to the target disease. Merely by way of example, according to analysis of a plurality of historical PET images relating to the tumor, it can be known that a boundary of the tumor may change gradually. Correspondingly, the abnormal point detection standard relating to the boundary of the abnormal point may include that the boundary of the target region changes gradually. As another example, according to analysis of a plurality of historical PET images relating to the tumor, it can be known that the SUVmax in the tumor is larger than a threshold. Correspondingly, the abnormal point detection standard relating to the SUV parameter of the abnormal point may include that the SUVmax of the target region is larger than the threshold.

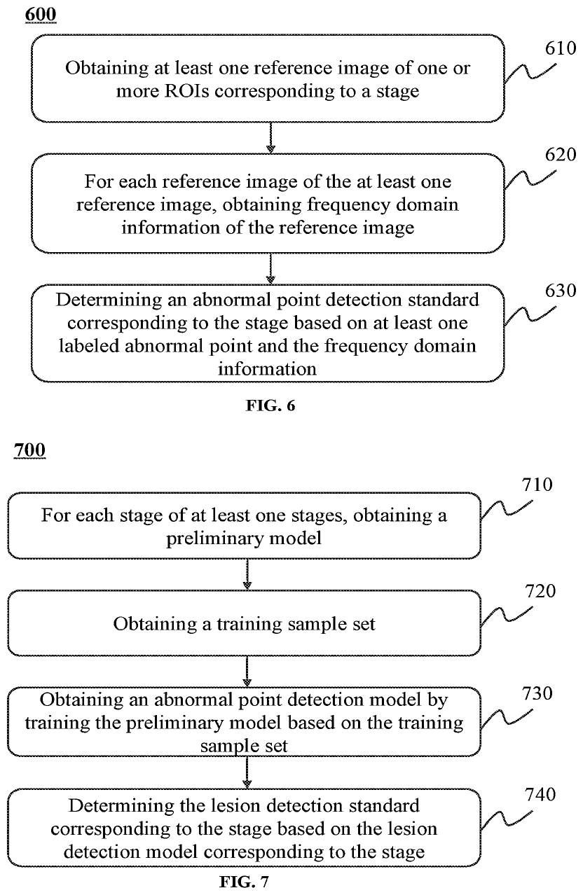

In some embodiments, the abnormal point detection standard corresponding to the stage can be determined based on frequency domain information of the functional image. For example, for each stage of the target disease, the processing device 140 may obtain at least one reference image of the one or more ROIs corresponding to the stage. The at least one reference image may be at least one second distribution image of the one or more ROIs corresponding to the stage determined based on the functional image. Each reference image of the at least one reference image may include at least one labeled abnormal point (also referred to as “a labeled lesion”). Further, for each reference image of the at least one reference image, the processing device 140 may obtain frequency domain information of the reference image. The abnormal point detection standard corresponding to the stage may be determined based on the labeled abnormal point and the frequency domain information of the at least one reference image. For example, the processing device 140 may perform a plurality of filtering operations on the frequency domain information of each reference image. The plurality of filtering operations may correspond to different cutoff frequencies. Then the processing device 140 may determine the abnormal point detection standard based on filtering results of the plurality of filtering operations and labeled abnormal point of the at least one reference image. More descriptions regarding determining the abnormal point detection standard based on the frequency domain information may be found elsewhere in the present disclosure. See, e.g., FIG. 6 and descriptions thereof.

In some embodiments, the abnormal point detection standard corresponding to the stage may be determined based on an abnormal point detection model (also referred to as “a lesion detection model”). The abnormal point detection model may be a trained machine learning model. For example, for each stage of the at least one stage, a preliminary model and a training sample set may be obtained. The training sample set may include a plurality of sample second distribution images of the one or more ROIs corresponding to the stage. Each sample second distribution image may include at least one labeled abnormal point. A trained abnormal point detection model may be obtained by training, based on the training sample set, the preliminary model. Further, the abnormal point detection standard corresponding to the stage may be determined based on the trained abnormal point detection model corresponding to the stage. More descriptions regarding determining the abnormal point detection standard based on the abnormal point detection model may be found elsewhere in the present disclosure. See, e.g., FIG. 7 and descriptions thereof.

In some embodiments, the user may input the abnormal point detection standard through an input device (e.g., the terminal device 130 in FIG. 1), and the processing device 140 may obtain the abnormal point detection standard from the input device. In some embodiments, the abnormal point detection standard may be obtained from a storage device (e.g., the storage device 150) disclosed elsewhere in this disclosure. For example, the abnormal point detection standard corresponding to the stage may be stored in the storage device 150. The processing device 140 may obtain information relating to the stage of the target disease (e.g., a name, a serial number of the target disease and/or the stage, etc.), and obtain the abnormal point detection standard from the storage device 150 based on the information relating to the stage.

In 520, the processing device 140 may generate an abnormal point detection result of the subject by performing, based on the abnormal point detection standard, an abnormal point detection operation on the second distribution image of the one or more ROIs corresponding to the stage.

In some embodiments, for the second distribution image corresponding to each stage, the processing device 140 may perform an abnormal point detection based on the abnormal point detection standard corresponding to the stage. In some embodiments, one or more target regions may be determined in the second distribution image, and the processing device 140 may perform an abnormal point detection on the one or more target regions based on the abnormal point detection standard corresponding to the stage. The target region may refer to one or more regions or volumes in the second distribution image. In some embodiments, the one or more target regions may be determined manually by the user. For example, the data attribute (e.g., gray value, etc.) of the abnormal point in the functional image may be different from that of a region without an abnormal point, and the user may outline the target region(s) in the second distribution image based on visual or empirical judgment.

In some embodiments, the target region may be determined based on SUV parameter(s). For example, for each ROI in the second distribution image, the processing device 140 may determine a position of an element (a voxel or a pixel) with the SUVmax in the ROI. Further, the processing device 140 may determine a region within a predetermined range around the position as the target region. Merely by way of example, the region within the predetermined range may include a region including one or more elements, wherein a ratio of the SUV of each element in the region to the SUVmax may be larger than or equal to a threshold (e.g., 30%, 40%, 50%, 60%, etc.). As another example, a region including elements whose SUVs are larger than a threshold may be determined as the target region.

Further, the processing device 140 may perform an abnormal point detection on the one or more target regions based on the abnormal point detection standard. For example, the abnormal point detection standard may include that the SUVmax in the target region is larger than an SUV threshold and a volume of the target region is smaller than a volume threshold. The processing device 140 may determine the SUVmax of each target region in the one or more target regions and the volume of the target region. Further, the processing device 140 may determine a target region that satisfies the abnormal point detection standard as an abnormal point. In some embodiments, the processing device 140 may directly determine a region in the second distribution image that satisfies the abnormal point detection standard and is located in the one or more ROIs as an abnormal point.

In some embodiments, the processing device 140 may generate the abnormal point detection result by performing the abnormal point detection operation based on two or more regions in the second distribution image. For example, the processing device 140 may determine a target element (e.g., a target pixel or a target voxel) with the SUVmax in the one or more ROIs in the second distribution image. Merely by way of example, for each ROI in the second distribution image, the processing device 140 may determine the target element with the SUVmax in the ROI. Further, the processing device 140 may respectively determine a first region and a second region around the target element. The first region and the second region may be closed regions surrounding the target element. The SUVs of elements in the first region may be in a first range determined based on the maximum SUV. The SUVs of elements in the second region may be in a second range determined based on the maximum SUV. In some embodiments, an area corresponding to the first range may be smaller than an area corresponding to the second range. For example, the first range may be 80% of SUVmax, and the second range may be 60% of the SUVmax. As another example, the first range may be 70% of the SUVmax, and the second range may be 40% of the SUVmax. Normally, the imaging agent in the subject may diffuse from a point with a high uptake concentration to the surrounding region. Correspondingly, the SUV may gradually decrease from the position of the target element to the surrounding region. In such cases, the area of the first region may be smaller than the area of the second region. In some embodiments, the first region may be within the second region. In some embodiments, the target element with the SUVmax in the one or more ROIs in the second distribution image may also refer to a target element with the SUVmax of all ROIs in the second distribution image.

Further, the processing device 140 may generate the abnormal point detection result based on the first region and the second region. In some embodiments, due to the abnormal uptake of the lesion (e.g., a tumor) in the subject to the imaging agent, the imaging agent may be relatively concentrated in the region where the lesion is located. Accordingly, in the functional image, a boundary of the region where the lesion is located may be clear and have a large gradient. For other uptakes (e.g., the physiological uptake, the background uptake, etc.), the imaging agent may diffuse in a region and the gradient of the boundary of the region may be small. In such cases, the processing device 140 may determine a volume difference between the first region and the second region, and generate the abnormal point detection result based on the volume difference. For example, if the volume difference is smaller than a volume difference threshold, which indicates that the imaging agent is concentrated in the region where the target element is located and a boundary of the region has a large gradient, the processing device 140 may determine that the region where the target element is located is a region including a lesion. If the volume difference is larger than the volume difference threshold, which indicates that the imaging agent in the region where the target element is located is widely distributed and the boundary of the region has a small gradient, the processing device 140 may determine that the region where the target element is located is a region without a lesion.

In some embodiments, the processing device 140 may also generate an abnormal point detection result based on the abnormal point detection standard described above and the volume difference. Merely by way of example, the abnormal point detection standard may include that the SUVmax is larger than an SUV threshold and the volume of the first region is less than a volume threshold. When the first region satisfies the abnormal point detection standard and the volume difference between the first region and the second region is smaller than the volume difference threshold, the processing device 140 may determine that the first region is the region where the tumor is located (i.e., the first region is an abnormal point).

According to the method described in the present disclosure, the abnormal point detection operation may be performed based on two or more regions, which may distinguish the lesion from the physiological uptake and/or the background uptake, and reduce false detection of abnormal points, thereby improving the accuracy of the abnormal point detection.

In some embodiments, the process 500 may also include an operation of performing medical analysis or determining a diagnosis and treatment result based on the abnormal point detection result. In some embodiments, operation 510 may be omitted. The processing device 140 may obtain an abnormal point detection model corresponding to each stage, and perform the abnormal point detection operation on the second distribution image corresponding to each stage using the abnormal point detection model. Optionally or additionally, a same abnormal point detection model may be used to perform the abnormal point detection operation on the second distribution image corresponding to each stage.

FIG. 6 is a flowchart illustrating an exemplary process for obtaining an abnormal point detection standard according to some embodiments of the present disclosure. In some embodiments, operation 510 in the process 500 may be performed according to the process 600.

In 610, the processing device 140 may obtain at least one reference image of the one or more ROIs corresponding to the stage.

In some embodiments, a reference image may include a second distribution image of a reference subject having the target disease at the stage. The second distribution image of the reference subject may be generated in a similar manner as how the second distribution image of the subject is generated as described in connection with FIG. 4. For example, the processing device 140 may obtain a reference structural image (e.g., a CT image, an MR image, etc.) and a corresponding reference functional image (e.g., a PET image, an SPECT image, etc.) of the reference subject. For example, the reference structural image and the corresponding reference functional image may be images acquired under a same scanning condition. In some embodiments, the processing device 140 may obtain a segmentation image of the one or more ROIs corresponding to the stage by performing image segmentation on the reference structural image of the reference subject. Further, the processing device 140 may generate the second distribution image of the reference subject by processing the reference functional image of the reference subject based on the segmentation image. The second distribution image of the reference subject may be used as the reference image of the one or more ROIs corresponding to the stage. In some embodiments, the reference image may include at least one labeled abnormal point (also referred to as “a labeled lesion”). For example, one or more abnormal points in each reference image may be labeled by a user manually. In some embodiments, the reference image may be obtained from a storage device (e.g., the storage device 150) disclosed elsewhere in the present disclosure. For example, the reference image may be a historical distribution image including at least one labeled abnormal point stored in the storage device.

In 620, for each reference image of the at least one reference image, the processing device 140 may obtain frequency domain information of the reference image.

In some embodiments, the processing device 140 may obtain a frequency domain image by performing a first image transformation operation on the reference image. The frequency domain image may include frequency domain information of the reference image. In some embodiments, the reference image may be a spatial domain image. The processing device 140 may obtain the frequency domain information of the reference image by performing the first image transformation operation on the reference image based on an image transformation algorithm. According to the first image transformation operation, the reference image may be transformed from the spatial domain to the frequency domain. Exemplary image transformation algorithms may include a Fourier transform algorithm, a wavelet transform algorithm, a Z transform algorithm, or the like, or any combination thereof.

In 630, the processing device 140 may determine the abnormal point detection standard corresponding to the stage based on the at least one labeled abnormal point and the frequency domain information.

In some embodiments, to determine the abnormal point detection standard corresponding to the stage, the processing device 140 may perform a plurality of filtering operations on the frequency domain information of each reference image. The plurality of filtering operations may correspond to different cutoff frequencies. For example, the processing device 140 may obtain filtering results corresponding to different cutoff frequencies by performing a plurality of filtering operations on the frequency domain image corresponding to the reference image. Further, the processing device 140 may determine the abnormal point detection standard based on the filtering results of the at least one reference image and the labeled abnormal point. In some embodiments, an abnormal point in an image may correspond to a specific frequency (or frequency range). The abnormal point may be retained or detected in the image by performing a filtering operation based on the specific frequency. In such cases, the processing device 140 may obtain the filtering results by performing the plurality of filtering operations on the frequency domain image corresponding to the reference image corresponding based on different cutoff frequencies. Further, the processing device 140 may determine one or more frequencies corresponding to the abnormal point based on the filtering results and the labeled abnormal point. Merely by way of example, the processing device 140 may obtain, by performing a second image transformation operation on the filtering results indicated by the frequency domain image, filtering results indicated by a spatial domain image. Further, the processing device 140 may determine a filtering result closest to the labeled abnormal point by comparing the spatial domain image with the reference image including the labeled abnormal point. The cutoff frequency corresponding to the filtering result closest to the labeled abnormal point may be determined as the abnormal point detection standard corresponding to the stage. For example, a region in the distribution image whose frequency is larger than or equal to the cutoff frequency may be determined as an abnormal point.

In some embodiments, the cutoff frequency may be used as a portion of the abnormal point detection standard. The cutoff frequency may be used in combination with other parameters when an abnormal point detection operation is performed. For example, the abnormal point detection standard may include that a frequency of the target region in the distribution image is larger than or equal to the cutoff frequency, an SUV parameter of the target region is larger than an SUV threshold, etc.

FIG. 7 is a flowchart illustrating an exemplary process for obtaining an abnormal point detection standard according to some embodiments of the present disclosure. In some embodiments, operation 510 in the process 500 may be performed according to the process 700.

In 710, the processing device 140 may obtain a preliminary model.

In some embodiments, the preliminary model may include a preliminary machine learning model. The preliminary machine learning model may include one or more model parameters having preliminary values. For example, the model parameters may include thresholds for determining the abnormal point (e.g., thresholds corresponding to the SUV parameters).

In 720, the processing device 140 may obtain a training sample set. The training sample set may include a plurality of sample distribution images of the one or more ROIs corresponding to the stage. Each sample distribution image of the plurality of sample distribution images may include at least one labeled abnormal point.

In some embodiments, the sample distribution image may be obtained from a storage device (e.g., the storage device 150) disclosed elsewhere in the present disclosure. For example, the sample distribution image may be a historical distribution image including the labeled abnormal point stored in the storage device. In some embodiments, the processing device 140 may obtain a sample structural image and a sample functional image of a sample subject from the storage device, a scanner, etc. Further, the processing device 140 may generate a first distribution image and a second distribution image of the sample subject according to the process 400 described in connection with FIG. 4. The second distribution image of the sample subject may be determined as the sample distribution image. Further, abnormal points in the sample distribution images may be labeled such that a training sample set may be obtained. For example, a training sample set including labeled abnormal points may be obtained by outlining or highlighting the abnormal points in the sample distribution images.

In 730, the processing device 140 may obtain an abnormal point detection model by training the preliminary model based on the training sample set.

In some embodiments, a training of the preliminary model may include one or more iterations. For illustration purposes, the following descriptions are described with reference to a current iteration. In the current iteration, the processing device 140 may input the sample distribution image of each training sample into the preliminary model to obtain predicted data (e.g., a predicted image including a predicted abnormal point). The processing device 140 may determine a value of a loss function based on the predicted data and the abnormal points labeled in the sample distribution image. The loss function may be used to measure a difference between the predicted image and the sample distribution image. Further, the processing device 140 may determine whether a termination condition is satisfied in the current iteration based on the value of the loss function. Exemplary termination conditions may include that the value of the loss function obtained in the current iteration is less than a predetermined threshold, a certain count of iterations is performed, that the loss function converges such that the differences of the values of the loss function obtained in consecutive iterations are within a threshold, or the like, or any combination thereof. In response to a determination result that the termination condition is satisfied in the current iteration, the processing device 140 may designate the preliminary model in the current iteration as the abnormal point detection model. In response to a determination result that the termination condition is not satisfied in the current iteration, the processing device 140 may update the preliminary model in the current iteration and perform a next iteration until the termination condition is satisfied. For example, the processing device 140 may update parameters of the preliminary model based on the value of the loss function.

In 740, the processing device 140 may determine the lesion detection standard corresponding to the stage based on the lesion detection model corresponding to the stage.

In some embodiments, the model parameters in the lesion detection model may include thresholds for determining a lesion. For example, the thresholds may be determined based on parameters of a judgment layer (e.g., a full connection layer) of the lesion detection model.

In some embodiments, two or more stages of the target disease may correspond to a same lesion detection model, and the lesion detection standard corresponding to each stage may be simultaneously obtained from the lesion detection model.

FIG. 8A is a schematic diagram illustrating an exemplary TNM distribution image 800A according to some embodiments of the present disclosure. The TNM distribution image 800A is a first distribution image generated by labeling the one or more ROIs corresponding to each stage in the TNM stages of a prostate cancer in a CT image of the patient. As shown in FIG. 8A, region Ta denotes the one or more ROIs corresponding to the Ta sub-stage in the T stage of the prostate cancer, region Tb denotes the one or more ROIs corresponding to the Tb sub-stage in the T stage of the prostate cancer, region N in a solid circle denotes the one or more ROIs corresponding to the N stage of the prostate cancer, and region M in a dotted box denotes the one or more ROIs corresponding to the M stage of the prostate cancer. In some embodiments, a second distribution image corresponding to each stage may be obtained by processing, based on the TNM distribution image, a functional image. The second distribution image may indicate the distribution of the one or more ROIs corresponding to each stage in the functional image.

In some embodiments, each stage of the target disease may correspond to an abnormal point detection standard. Merely by way of example, as shown in FIG. 8A, the abnormal point detection standard corresponding to the T stage (e.g., Ta and/or Tb sub-stage) may include that the SUVmax of a target region in the region Ta and/or region Tb is larger than 4 kBq/ml; the abnormal point detection standard corresponding to the N stage may include the that the SUVmax of a target region in region N is larger than 4 kBq/ml, and a volume of the target region is less than 40 mm³; the abnormal point detection standard corresponding to the M stage may include that the SUVmax of a target region in region M is larger than 3 kBq/ml, and the volume of the target region is less than 30 mm³.

It should be noted that the TNM distribution image and abnormal point detection standard illustrated in FIG. 8A are merely provided for the purposes of illustration, and not intended to limit the scope of the present disclosure. For persons having ordinary skills in the art, multiple variations or modifications may be made under the teachings of the present disclosure. In some embodiments, each stage of the target disease may correspond to one or more TNM distribution images. For example, the one or more ROIs corresponding to the Ta sub-stage, the Tb sub-stage, the N stage, and the M stage of the prostate cancer illustrated in FIG. 8A may also be respectively displayed in a TNM distribution image, such that a user may determine a stage of the target disease by performing an abnormal point detection operation on a respective distribution image corresponding to each stage. For example, FIG. 8B is a schematic diagram illustrating another exemplary TNM distribution image 800B according to some embodiments of the present disclosure. As illustrated in FIG. 8B, (a) is a T distribution image, (b) is an N distribution image, and (c) is an M distribution image, the one or more ROIs corresponding to each stage are respectively displayed in the distribution images. In some embodiments, two or more stages of the target disease may correspond to a same abnormal point detection standard.

FIG. 9 is a flowchart illustrating an exemplary process for generating a lesion detection result according to some embodiments of the present disclosure. In some embodiments, operation 440 in the process 400 may be performed according to the process 900. In some embodiments, the process 900 may be performed by the detection module 340.

In 910, the processing device 140 may generate a preliminary lesion detection result based on the second distribution image.

In some embodiments, the processing device 140 may generate the preliminary lesion detection result according to the method described in connection with operation 440.

In 920, the processing device 140 may generate the lesion detection result by verifying the preliminary lesion detection result based on at least one of the first distribution image or the structural image.

In some embodiments, the processing device 140 may determine one or more lesions in the first distribution image or the structural image based on the preliminary lesion detection result. Further, the processing device 140 may determine the lesion detection result by verifying the preliminary lesion detection result. For example, the processing device 140 may perform image registration on the second distribution image and the first distribution image or the structural image. Further, the processing device 140 may map the preliminary lesion detection result in the registered distribution image to the first distribution image or the structural image. As another example, the processing device 140 may perform image fusion on the second distribution image and the first distribution image or the structural image, such that the preliminary lesion detection result may be fused into the first distribution image or the structural image. Further, the processing device 140 may verify the lesion in the first distribution image or the structural image. Taking a verification based on the structural image as an example, the structural image may reflect the structural information of different parts of the subject, such that one or more body parts (e.g., organs, tissues, lesions, etc.) corresponding to the lesion in the preliminary lesion detection result may be determined in the structural image. If the lesion is located in a body part that does not usually have a lesion (e.g., the adipose tissue), the lesion may not be a true lesion and needs to be excluded or be further verified (e.g., be verified manually). If the lesion is located in a body part that is likely to have a lesion (e.g., the bone), the lesion in the preliminary lesion detection result may be a true lesion. In some embodiments, a final lesion detection result may be generated by retaining the lesions verified as true lesions in the preliminary lesion detection result. For example, the true lesions may be labeled in the structural image.

According to the method described in the present disclosure, the preliminary lesion detection result determined in the second distribution image (or the functional image) may be verified in the structural image. In such cases, interferences of the body parts that usually do not have lesions on the lesion detection operation may be reduced, which may reduce false detection of lesions, thereby improving the accuracy of lesion detection.

FIG. 10 is a flowchart illustrating an exemplary process for image processing according to some embodiments of the present disclosure.

In 1010, the processing device 140 may obtain a structural image and a functional image of a subject.

More descriptions regarding the structural image and the functional image may be found elsewhere in the present disclosure. See, e.g., operations 420 and 430.

In 1020, the processing device 140 may simultaneously generate a distribution image of one or more ROIs in the subject and a lesion detection image of the subject by processing the structural image and the functional image of the subject using an image processing model. The lesion detection image may indicate a lesion detection result relating to a target disease.

In some embodiments, the processing device 140 may input the structural image and the functional image into the image processing model, and obtain the distribution image and the lesion detection image using the image processing model. In some embodiments, the distribution image may correspond to the structural image. For example, the distribution image may be an image obtained by performing image segmentation on the structural image. The distribution image may include structural information of the one or more ROIs of the subject. In some embodiments, the lesion detection image may correspond to the functional image. For example, the lesion detection image may be a lesion detection result indicated on the functional image. For example, the lesion detection image may be obtained by determining (e.g., outlining, marking, etc.), on the functional image, a region where the lesion is located. As another example, the lesion detection image may be obtained by determining, on the functional image, a region where the lesion is located and regions where the one or more ROIs (e.g., organs, tissues, etc.) are located.

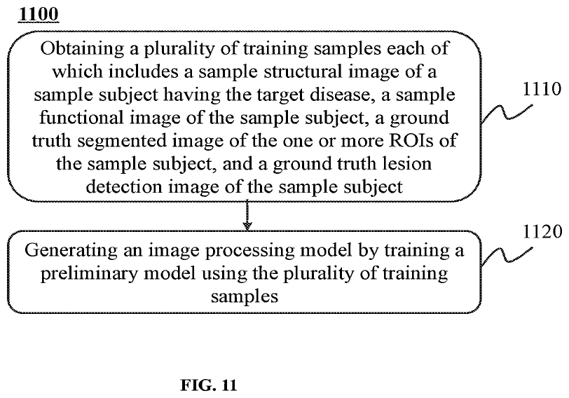

In some embodiments, the image processing model may be obtained according to a model training process. For example, the processing device 140 may obtain a plurality of training samples each of which includes a sample structural image of a sample subject having the target disease, a sample functional image of the sample subject, a ground truth distribution image of the one or more ROIs of the sample subject, and a ground truth lesion detection image of the sample subject. Further, the processing device 140 may generate the image processing model by training a preliminary model using the plurality of training samples. More descriptions regarding training the preliminary model may be found elsewhere in the present disclosure. See, e.g., FIG. 11 and descriptions thereof.

In some embodiments, the image processing model may be stored in a storage device (e.g., the storage device 150), and the processing device 140 may obtain the image processing model from the storage device.

In 1030, the processing device 140 may determine a stage of the target disease based on the lesion detection result and a staging criterion relating to the target disease.

In some embodiments, as described in connection with FIG. 4, each stage of the target disease may correspond to one or more ROIs of specific types. The types of the one or more ROIs may indicate the regions (or body parts) where the target disease at the current stage is probably distributed in the subject. The staging criterion may be used to determine the stage of the target disease and the type of the one or more ROIs corresponding to the stage. The processing device 140 may obtain the staging criterion relating to the target disease, and determine the stage of the target disease based on the staging criterion and the lesion detection result. For example, the processing device 140 may determine, based on the lesion detection result, whether there is a lesion in the subject and one or more ROIs where the lesion is located. Further, if there is a lesion in the subject, the processing device 140 may determine the stage of the target disease based on the ROI where the lesion is located and the type of the one or more ROIs corresponding to each stage. In some embodiments, operation 1030 may be omitted.

FIG. 11 is a flowchart illustrating an exemplary process for determining an image processing model according to some embodiments of the present disclosure. In some embodiments, the image processing model illustrated in FIG. 10 may be trained according to the process 1100.

In 1110, the processing device 140 may obtain a plurality of training samples.

In some embodiments, each training sample may include a sample structural image of a sample subject having the target disease, a sample functional image of the sample subject, a ground truth distribution image of the one or more ROIs of the sample subject, and a ground truth lesion detection image of the sample subject.

In some embodiments, the sample structural image and the sample functional image may be images of the sample subject acquired under a same scanning condition. The same scanning condition may include a same time, a same physiological phase (e.g., a respiratory phase, a cardiac phase, etc.), etc. In some embodiments, the processing device 140 may obtain the sample structural image and the sample functional image directly from one or more imaging devices. In some embodiments, the processing device 140 may obtain the sample structural image and the sample functional image from a storage device (e.g., the storage device 150) disclosed elsewhere in the present disclosure.

In some embodiments, the ground truth distribution image may correspond to a stage of the target disease. For example, for each stage of the target disease, the processing device 140 may obtain a ground truth distribution image corresponding to the stage. In some embodiments, to obtain the ground truth distribution image, the processing device 140 may obtain a staging criterion relating to the target disease. Further, the processing device 140 may determine a type of one or more ROIs corresponding to the stage based on the staging criterion. Further, the processing device 140 may determine the ground truth distribution image of each training sample based on the type of the one or more ROIs. For example, for each stage of the target disease, the processing device 140 may generate the ground truth distribution image of each training sample by performing, based on the type of the one or more ROIs, image segmentation on the sample structural image. In some embodiments, the ground truth distribution image may be generated based on the staging criterion in a similar manner as how the first distribution image is generated as described in connection with FIG. 4. In some embodiments, the ground truth distribution image may include all ROIs in the sample subject. For example, the processing device 140 may determine all ROIs in the sample structural image by performing image segmentation on the sample structural image.

In some embodiments, to obtain the ground truth lesion detection image, the processing device 140 may generate a sample distribution image of the one or more ROIs by processing the sample functional image based on the ground truth distribution image. Further, the processing device 140 may generate the ground truth lesion detection image based on the sample distribution image. In some embodiments, the processing device 140 may generate the ground truth lesion detection image based on a lesion detection standard. For example, the processing device 140 may obtain the lesion detection standard corresponding to the target disease. Further, the processing device 140 may generate the ground truth lesion detection image by performing, based on the lesion detection standard, a lesion detection operation on the sample distribution image. The lesion detection standard may include the abnormal point detection standard described above. More descriptions regarding the abnormal point detection standard may be found elsewhere in the present disclosure. See, e.g., FIGS. 6-7 and descriptions thereof.

In some embodiments, the processing device 140 may generate the ground truth lesion detection image based on a lesion detection model. For example, the processing device 140 may obtain a lesion detection model corresponding to the target disease. Further, the processing device 140 may generate the ground truth lesion detection image by performing, using the lesion detection model, a lesion detection operation on the sample distribution image. In some embodiments, the processing device 140 may generate the ground truth lesion detection image based on two or more regions in the sample distribution image. The method of generating the ground truth lesion detection image based on two or more regions in the sample distribution image may be similar to the method of generating the lesion detection result based on two or more regions in the second distribution image as described in connection with FIG. 5, which will not be repeated here.

In some embodiments, the ground truth distribution image and/or the ground truth lesion detection image may be generated manually. For example, a doctor may label the one or more ROIs in the sample structural image such that the ground truth distribution image may be obtained. As another example, a doctor may label lesions in the sample functional image such that the ground truth lesion detection image may be generated. In some embodiments, a preliminary ground truth distribution image and/or a preliminary ground truth lesion detection image may be generated automatically according to the methods described in the present disclosure. Then the preliminary ground truth distribution image and/or the preliminary ground truth lesion detection image may be confirmed and/or modified manually to generate the ground truth distribution image and the ground truth lesion detection image.

In 1120, the processing device 140 may generate the image processing model by training a preliminary model using the plurality of training samples.

In some embodiments, a training of the preliminary model may include one or more iterations. For illustration purposes, the following descriptions are described with reference to a current iteration. In the current iteration, the processing device 140 may input the sample structural image and the sample functional image of each training sample into the preliminary model to obtain predicted images (e.g., a predicted distribution image and a predicted lesion detection image). The processing device 140 may determine a value of a loss function based on the predicted images and ground truth images (e.g., the ground truth distribution image and the ground truth lesion detection image). The loss function may be used to measure a difference between the predicted images and the ground truths. Further, the processing device 140 may determine whether a termination condition is satisfied in the current iteration. Exemplary termination conditions may include that the value of the loss function obtained in the current iteration is less than a predetermined threshold, a certain count of iterations is performed, that the loss function converges such that the differences of the values of the loss function obtained in consecutive iterations are within a threshold, or the like, or any combination thereof. In response to a determination result that the termination condition is satisfied in the current iteration, the processing device 140 may designate the preliminary model in the current iteration as the image processing model. In response to a determination result that the termination condition is not satisfied in the current iteration, the processing device 140 may update the preliminary model in the current iteration and perform a next iteration until the termination condition is satisfied. For example, the processing device 140 may update parameters of the preliminary model based on the value of the loss function. In some embodiments, the preliminary model may include a multi-task model.

According to the method described in the present disclosure, the input of the model training process may include both a structural image and a functional image, and the ground truth may include a distribution image corresponding to the structural image and a lesion detection image corresponding to the functional image. The preliminary model may be trained based on the training samples such that the preliminary model may learn the type of one or more ROIs reflected in the ground truth distribution image and thereby learning the staging criterion corresponding to the target disease while learning lesion detection mechanisms. In such cases, in a process of generating lesion detection images, the image processing model may perform the lesion detection operation based on the staging criterion, which may improve the accuracy of lesion detection and improve the efficiency of lesion detection.

The beneficial effects that the embodiments of the present disclosure may include, but are not limited to: (1) The image processing method according to some embodiments of the present disclosure may determine the type of the one or more ROIs corresponding to the stage of the target disease based on the staging criterion relating to the target disease, such that the possible metastasis pathway of the target disease may be determined. Further, the metastasis pathway may be reflected in the first distribution image. Furthermore, the second distribution image may be obtained based on the first distribution image and the functional image, such that the metastasis pathway may be displayed in the second distribution image, which may solve the problem that it is difficult to determine the one or more ROIs corresponding to each stage directly on the functional image due to the limited structural information included in the functional image; (2) The lesion detection operation may be performed based on the metastasis pathway reflected in the second distribution image, such that the lesion detection operation may be performed more purposefully, which may reduce the problems such as missing detection, false detection, etc., and improve the efficiency and accuracy of the lesion detection; (3) The second distribution image may be used to distinguish the region where the target disease is distributed from other regions of the subject, which may reduce or eliminate the influence of physiological uptake in other regions on the lesion detection, thereby avoiding missing detection, and improving the sensitivity and accuracy of the lesion detection; (4) The image processing method according to some embodiments of the present disclosure may determine the lesion detection standard corresponding to each stage based on the one or more parameters such as a type of the imaging agent, a type of the target disease, the stage of the target disease, individual information of the subject, such that the lesion detection standard may have strong specificity, which may improve the sensitivity and accuracy of the lesion detection; (5) The image processing method according to some embodiments of the present disclosure may perform the lesion detection operation using a trained image processing model. The input of the model training process may include both a structural image and a functional image, and the ground truth may include a distribution image corresponding to the structural image and a lesion detection image corresponding to the functional image. The preliminary model may be trained based on the training samples such that the preliminary model may learn the type of one or more ROIs reflected in the ground truth distribution image and thereby learning the staging criterion corresponding to the target disease while learning lesion detection mechanisms. In such cases, in a process of generating lesion detection images, the image processing model may perform the lesion detection operation based on the staging criterion, which may improve the accuracy of lesion detection and improve the efficiency of lesion detection. It should be noted that different embodiments may have different beneficial effects, and in different embodiments, the possible beneficial effects may be any one or a combination of the above, or any other possible beneficial effects.

In some embodiments, the one or more operations in a process described above (e.g., the process 400, the process 500, etc.) may be performed in the imaging system 100 illustrated in FIG. 1. For example, the process may be stored in the storage device 150 in the form of instructions, and invoked and/or executed by the processing device 140. In some embodiments, the process may also be implemented in the terminal device 130. It should be noted that the above descriptions of the process are merely provided for the purposes of illustration, and not intended to limit the scope of the present disclosure. For persons having ordinary skills in the art, multiple variations or modifications may be made under the teachings of the present disclosure. In some embodiments, the operations in the process are not sequential. In some embodiments, the process may include one or more additional operations or one or more operations of the process may be omitted. In some embodiments, at least two operations in the process may be combined into one operation, or one operation in the process may be divided into two operations.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction performing system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local region network (LAN) or a wide region network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for image processing, implemented on a computing device having at least one storage device storing a set of instructions, and at least one processor in communication with the at least one storage device, the method comprising:
for each stage of at least one stage of a target disease,
determining a type of one or more regions of interest (ROIs) corresponding to the stage;
generating a first distribution image indicating the distribution of the one or more ROIs corresponding to the stage in a subject by processing a structural image of the subject based on the type of the one or more ROIs; and
generating a lesion detection result of the subject by processing a functional image of the subject based on the first distribution image corresponding to the stage.

2. The method of claim 1, wherein the determining a type of one or more ROIs corresponding to the stage includes:
obtaining a staging criterion relating to the target disease; and
determining the type of the one or more ROIs corresponding to the stage based on the staging criterion.

3. The method of claim 2, wherein the staging criterion includes a TNM staging criterion, the type of the one or more ROIs includes at least one of: a local region corresponding to T stage, an adjacent region corresponding to N stage, or a distant region corresponding to M stage.

4. The method of claim 1, wherein the generating a lesion detection result of the subject by processing a functional image of the subject based on the first distribution image corresponding to the stage includes:
generating a second distribution image indicating the distribution of the one or more ROIs corresponding to the stage in the subject by processing the functional image based on the first distribution image; and
generating the lesion detection result of the subject based on the second distribution image.

5. The method of claim 4, wherein the generating the lesion detection result of the subject based on the second distribution image of the one or more ROIs corresponding to the stage includes:
obtaining a lesion detection standard corresponding to the stage; and
generating the lesion detection result of the subject by performing, based on the lesion detection standard, a lesion detection operation on the second distribution image of the one or more ROIs corresponding to the stage.

6. The method of claim 5, wherein the obtaining a lesion detection standard corresponding to the stage includes:
obtaining at least one reference image of the one or more ROIs corresponding to the stage, each reference image of the at least one reference image including at least one labeled lesion;
for each reference image of the at least one reference image, obtaining frequency domain information of the reference image; and
determining the lesion detection standard corresponding to the stage based on the at least one labeled lesion and the frequency domain information.

7. The method of claim 4, wherein the generating the lesion detection result of the subject based on the second distribution image of the one or more ROIs corresponding to the stage includes:
obtaining a lesion detection model corresponding to the stage; and
generating the lesion detection result of the subject by performing, using the lesion detection model, lesion detection operation on the second distribution image of the one or more ROIs corresponding to the stage.

8. The method of claim 4, wherein the generating the lesion detection result of the subject based on the second distribution image of the one or more ROIs corresponding to the stage includes:
determining a target element with the maximum standardized uptake value (SUV) in the one or more ROIs in the second distribution image;
determining a first region around the target element, wherein the SUVs of elements in the first region are in a first range determined based on the maximum SUV;
determining a second region around the target element, wherein the SUVs of elements in the second region are in a second range determined based on the maximum SUV; and
generating the lesion detection result based on the first region and the second region.

9. The method of claim 4, wherein the generating the lesion detection result of the subject based on the second distribution image of the one or more ROIs corresponding to the stage further includes:
generating a preliminary lesion detection result of the subject based on the second distribution image; and
generating the lesion detection result by verifying the preliminary lesion detection result based on at least one of the first distribution image or the structural image.

10. The method of claim 1, wherein the method further includes:
display the lesion detection result of the subject on the first distribution image.

11. A system for imaging processing, comprising:
at least one storage medium including a set of instructions; and
at least one processor in communication with the at least one storage medium, wherein when executing the set of instructions, the at least one processor is directed to cause the system to perform operations including:
for each stage of at least one stage of a target disease,
determining a type of one or more regions of interest (ROIs) corresponding to the stage;
generating a first distribution image indicating the distribution of the one or more ROIs corresponding to the stage in a subject by processing a structural image of the subject based on the type of the one or more ROIs; and
generating a lesion detection result of the subject by processing a functional image of the subject based on the first distribution image corresponding to the stage.

12. The system of claim 11, wherein the determining a type of one or more ROIs corresponding to the stage includes:
obtaining a staging criterion relating to the target disease; and
determining the type of the one or more ROIs corresponding to the stage based on the staging criterion.

13. The system of claim 12, wherein the staging criterion includes a TNM staging criterion, the type of the one or more ROIs includes at least one of: a local region corresponding to T stage, an adjacent region corresponding to N stage, or a distant region corresponding to M stage.

14. The system of claim 11, wherein the generating a lesion detection result of the subject by processing a functional image of the subject based on the first distribution image corresponding to the stage includes:
generating a second distribution image indicating the distribution of the one or more ROIs corresponding to the stage in the subject by processing the functional image based on the first distribution image; and
generating the lesion detection result of the subject based on the second distribution image.

15. The system of claim 14, wherein the generating the lesion detection result of the subject based on the second distribution image of the one or more ROIs corresponding to the stage includes:
obtaining a lesion detection standard corresponding to the stage; and
generating the lesion detection result of the subject by performing, based on the lesion detection standard, a lesion detection operation on the second distribution image of the one or more ROIs corresponding to the stage.

16. The system of claim 15, wherein the obtaining a lesion detection standard corresponding to the stage includes:
obtaining at least one reference image of the one or more ROIs corresponding to the stage, each reference image of the at least one reference image including at least one labeled lesion;
for each reference image of the at least one reference image, obtaining frequency domain information of the reference image; and
determining the lesion detection standard corresponding to the stage based on the at least one labeled lesion and the frequency domain information.

17. The system of claim 14, wherein the generating the lesion detection result of the subject based on the second distribution image of the one or more ROIs corresponding to the stage includes:
obtaining a lesion detection model corresponding to the stage; and
generating the lesion detection result of the subject by performing, using the lesion detection model, lesion detection operation on the second distribution image of the one or more ROIs corresponding to the stage.

18. The system of claim 14, wherein the generating the lesion detection result of the subject based on the second distribution image of the one or more ROIs corresponding to the stage includes:
determining a target element with the maximum standardized uptake value (SUV) in the one or more ROIs in the second distribution image;
determining a first region around the target element, wherein the SUVs of elements in the first region are in a first range determined based on the maximum SUV;
determining a second region around the target element, wherein the SUVs of elements in the second region are in a second range determined based on the maximum SUV; and
generating the lesion detection result based on the first region and the second region.

19. The system of claim 14, wherein the generating the lesion detection result of the subject based on the second distribution image of the one or more ROIs corresponding to the stage further includes:
generating a preliminary lesion detection result of the subject based on the second distribution image; and
generating the lesion detection result by verifying the preliminary lesion detection result based on at least one of the first distribution image or the structural image.

20. A non-transitory computer readable medium, comprising executable instructions that, when executed by at least one processor, direct the at least one processor to perform a method, the method comprising:
for each stage of at least one stage of a target disease,
determining a type of one or more regions of interest (ROIs) corresponding to the stage;
generating a first distribution image indicating the distribution of the one or more ROIs corresponding to the stage in a subject by processing a structural image of the subject based on the type of the one or more ROIs; and
generating a lesion detection result of the subject by processing a functional image of the subject based on the first distribution image corresponding to the stage.
